(19) United States
(12) Patent Application Publication
(10) Pub. No.: US 2022/0243517 A1
(43) Pub. Date: Aug. 4, 2022

(54) INDUCTIVE SENSOR FOR POWER SLIDING DOORS

(71) Applicant: MAGNA CLOSURES INC., Newmarket (CA)

(72) Inventors: Junchao Liu, Richmond Hill (CA); Michael Bayley, Unionville (CA)

(21) Appl. No.: 17/575,964

(22) Filed: Jan. 14, 2022

Related U.S. Application Data
(60) Provisional application No. 63/145,761, filed on Feb. 4, 2021.

(51) Int. Cl. E05F 15/659; E05F 15/662; B60J 5/06

(52) U.S. Cl. CPC E05F 15/659; E05F 15/662; B60J 5/06; E05Y 2201/434; E05Y 2900/531; E05Y 2201/664; E05Y 2201/716; E05Y 2400/334; E05Y 2201/654

(57) ABSTRACT

A drive mechanism control system and method of operation are provided. The system includes a motor for rotating an output shaft about a primary central axis. The system also includes a powered drive mechanism including a rotatable component attached to the output shaft. The system also includes a coil and a target attached to the rotatable component and configured to have a fluctuating inductive coupling with the coil. The system additionally includes an electronic control unit coupled to the coil and configured to generate a magnetic field adjacent to the target using the coil. The electronic control unit senses a variation of the magnetic field due to the fluctuating inductive coupling with the target as the rotatable component is rotated. The electronic control unit is also configured to determine an absolute position of the rotatable component based on sensing the variation of the magnetic field.

### CROSS REFERENCE TO RELATED APPLICATIONS

This utility application claims the benefit of U.S. Provisional Application No. 63/145,761 filed Feb. 4, 2021. The entire disclosure of the above application is incorporated herein by reference.

### FIELD

The present disclosure relates generally to motor vehicle closure panels, and more particularly to motor vehicle sliding closure panels and an inductive sensor therefor.

### BACKGROUND

This section provides background information related to the present disclosure which is not necessarily prior art.

Many motor vehicle sliding door assemblies are configured for sliding movement between open and closed positions via actuation of a motor operably coupled to a cable actuation mechanism. The cable actuation mechanism typically includes a pair of cables having first ends coupled to a cable-operated drive mechanism, also referred to as cable drum mechanism, and second ends operably coupled to the sliding door, whereupon driven movement of the cables via a motor causes sliding movement of a sliding door between open and closed positions. Typically, as shown schematically in FIG. 1, a powered sliding door assembly includes a motor 1 that drives a drive shaft 2 via one or more gears, shown as a drive worm gear 3 and a driven worm gear 4. Driven worm gear 4 is shown operably connected to drive shaft 2 via a clutch 5, wherein clutch 5 rotatably drives drive shaft 2 in the desire direction of rotation to cause the sliding door to slide between the open and closed positions. In response to rotation of the drive shaft 2, a cable drum mechanism, shown as having a first cable drum portion or member 6a and a second cable drum portion or member 6b, is rotatably driven to cause a first cable 7a wrapped about first cable drum member 6a and a second cable 7b wrapped about second cable drum member 6b to drive the sliding door between the open and closed positions. As first and second cable drum portions 6a, 6b are rotated conjointly by drive shaft 2 about a common axis A, if first cable 7a is wrapped about first cable drum portion 6a, then second cable 7b is unwrapped about second cable drum portion 6b. Accordingly, as first cable 7a is being wrapped, second cable 7b is being unwrapped, and vice versa.

In the above sliding door assemblies, and in other known sliding door assemblies, the first cable drum member 6a and the second cable drum member 6b, whether formed as separate pieces of material from one another or from a monolithic piece of material, are configured in coaxially stacked relation with one another on the drive shaft 2 relative to axis A, such that they share and are configured for rotation about the common axis A. Accordingly, the first cable drum member 6a and the second cable drum member 6b are axially spaced from one another coaxially along axis A. Although such cable actuation mechanisms function well for their intended use, they come with potential draw backs, with one such draw back being the amount of space required, and in particular, the amount of vertical (axial) space (extending upwardly from a ground surface) required for assembly to the motor vehicle, due primarily to the vertically stacked first and second cable drum members 6a, 6b. Further yet, the problem becomes worse if the first and second cables 7a, 7b ride along grooves within the first and second cable drum members 6a, 6b with each the first and second cables 7a, 7b not overlapping themselves, as this causes the axial height of the first and second cable drum members 6a, 6b to be increased. It is desirable to not have the cables overlap themselves to reduce the potential for the cables to flatten against each other and from slipping relative to each other, which in turn can reduce the reliability of position detection. However, in order to avoid the increase in axial height of the cable drive mechanism, the first and second cables 7a, 7b are commonly provided to overlap themselves. Accordingly, known cable actuation mechanisms can ultimately have an impact on design freedom, such as by requiring a relatively large space within the motor vehicle and limiting the potential location suitable for their attachment. Generally, such known cable actuation mechanisms are not suited for location along a floor board of the motor vehicle, but require locations having increased vertically extending space, and thus, design options are limited. Further yet, known cable actuation mechanisms typically require selecting certain benefits, such as no cable overlapping or reduced axial height, for example, while realizing the selection of one results in forfeiture of the other. Effective operation of such sliding door assemblies additionally requires accurate sensing of the position of various components of the cable drive mechanism. However, addition of some sensing assemblies can further complicate the cable overlapping or reduced axial height design choices.

In view of the above, there remains a need to provide cable actuation mechanisms and control systems for motor vehicle powered sliding door assemblies that facilitate ease of assembly, that are efficient in operation, while at the same time being compact, robust, durable, lightweight and economical in manufacture, assembly, and in use.

### SUMMARY

This section provides a general summary of the disclosure and is not intended to be a comprehensive listing of all features, advantages, aspects and objectives associated with the inventive concepts described and illustrated in the detailed description provided herein.

It is an object of the present disclosure to provide cable-operated drive mechanisms for a motor vehicle sliding door assemblies that address at least some of those issues discussed above with known cable-operated drive mechanisms.

In accordance with the above object, it is an aspect of the present disclosure to provide a position sensor assembly for sensing an absolute position of a rotatable component of a powered drive mechanism rotating about a primary central axis. The position sensor assembly includes a coil being annularly shaped about the primary central axis in a first plane. In addition, the position sensor assembly includes a metallic ring of metal being annularly shaped and attached to the rotatable component and substantially coaxial with the coil in a second plane parallel to and in a spaced relationship with the first plane and configured to have a fluctuating inductive coupling with the coil varying continuously as the metallic ring is rotated about the primary central axis relative to the coil. The position sensor assembly also includes an induction sensor circuitry unit coupled to the coil and configured to energize the coil and generate a magnetic field around the coil and detect the fluctuating inductive coupling.

According to an aspect, the metallic ring has a ring top and a ring bottom opposite the ring top to define a ring thickness therebetween. The metallic ring extends radially outwardly from a secondary central axis not coaxial with the primary central axis to an outer ring perimeter that is circular with a first ring diameter. The metallic ring defines a ring opening that is circular and is disposed about the primary central axis and extends through the metallic ring and has a second ring diameter less than the first ring diameter.

According to another aspect, the metallic ring is formed of steel.

According to yet another aspect, the coil and the induction sensor circuitry unit are both disposed on a sensor printed circuit board extending along the first plane.

In another aspect of the disclosure, a drive mechanism control system is also provided. The drive mechanism control system includes a motor for rotating an output shaft about a primary central axis. The drive mechanism control system also includes a powered drive mechanism including a rotatable component attached to the output shaft and configured to rotate about the primary central axis. The drive mechanism control system also includes a coil and a target attached to the rotatable component and configured to have a fluctuating inductive coupling with the coil. The drive mechanism control system additionally includes an electronic control unit coupled to the coil. The electronic control unit is configured to generate a magnetic field adjacent to the target using the coil. The electronic control unit senses a variation of the magnetic field due to the fluctuating inductive coupling with the target as the rotatable component is rotated. The electronic control unit is also configured to determine an absolute position of the rotatable component based on sensing the variation of the magnetic field.

In yet another aspect of the disclosure, a method of operating a drive mechanism control system is also provided. The method includes the step of providing a target on a rotatable component being rotatable about a primary central axis. The method continues with the step of generating a magnetic field adjacent to the target. The next step of the method is sensing a variation of the magnetic field due to a fluctuating inductive coupling with the target as the rotatable component is rotated. The method also includes the step of determining an absolute position of the rotatable component based on sensing the variation of the magnetic field.

In a further aspect of the disclosure, a powered sliding door drive unit for moving a sliding door between an open position and a closed position is provided. The powered sliding door drive unit includes at least one cable drum for winding and unwinding of a cable coupled to the sliding door. The powered sliding door drive unit also includes a motor operably coupled to the at least one cable drum for rotating the at least one cable drum to move the sliding door during winding and unwinding of the cable. In addition, the powered sliding door drive unit includes an induction sensor adapted to detect an electromagnetic field and an object coupled to the at least one cable drum. The object changes the electromagnetic field during rotating of the at least one cable drum and the induction sensor is further adapted to detect the change in the electromagnetic field.

In a further aspect of the disclosure, a powered sliding door drive unit for moving a sliding door between an open position and a closed position includes at least one cable drum for winding and unwinding of a cable coupled to the sliding door, a motor operably coupled to the at least one cable drum for rotating the at least one cable drum to move the sliding door during winding and unwinding of the cable, and a proximity sensor adapted to detect the change in the position of the at least one cable drum.

In a related aspect, the proximity sensor is configured to generate an electromagnetic field.

In a related aspect, the proximity sensor is configured to both generate an electromagnetic field and detect a change in the generated electromagnetic field.

Further areas of applicability will become apparent from the description provided herein. The description and specific examples in this summary are only intended to illustrate certain non-limiting embodiments which are not intended to limit the scope of the present disclosure.

### BRIEF DESCRIPTION OF THE DRAWINGS

These and other aspects, features, and advantages of the present disclosure will be readily appreciated, as the same becomes better understood by reference to the following detailed description when considered in connection with the accompanying drawings wherein:

FIG. 1 is a schematic elevation view of a cable-operated drive mechanism constructed in accordance with the prior art;

FIG. 2 illustrates a motor vehicle with a sliding door assembly having a sliding door drive assembly including a cable-operated drive mechanism in accordance with an aspect of the disclosure, with the sliding door assembly shown in a closed state;

FIG. 2A is a view similar to FIG. 2 with the sliding door assembly shown in an open state;

FIG. 2B is a view similar to FIG. 2 with the sliding door assembly shown in an open state, and illustrating the positioning of the sliding door drive assembly at positions above or below an opening in the vehicle body;

FIG. 2C is a view similar to FIG. 2 with the sliding door assembly shown in an open state, and the vehicle being an electrical vehicle having a power battery pack;

FIG. 3 is a schematic illustration of a cable assembly extending outwardly from a housing of the cable-operated drive mechanism of the sliding door assembly of FIGS. 2 and 2A with the cable assembly being routed about pulleys configured to be fixed to a quarter panel of the motor vehicle and being operably coupled to a slide member fixed to the motor vehicle sliding door in accordance with one aspect of the disclosure;

FIG. 4 is a perspective view of a cable-operated drive mechanism configured in accordance with an aspect of the disclosure;

FIG. 5 is an exploded view of the cable-operated drive mechanism of FIG. 4;

FIG. 6 is a perspective view similar to FIG. 4 with a housing removed for clarity of internal components;

FIG. 7 is a flow diagram illustrating a method of minimizing the axial height of a cable-operated drive mechanism for a powered motor vehicle sliding closure panel in accordance with another aspect of the disclosure;

FIG. 8A is a schematic side view of the cable-operated drive mechanism of FIG. 4 showing the cable drums arranged in a common plane;

FIG. 8B is a schematic side view of a cable-operated drive mechanism in accordance with another aspect of the disclosure showing the cable drums arranged in axially offset relation with one another in non-overlapping planes;

FIG. 9 is a perspective view of a cable-operated drive mechanism configured in accordance with another aspect of the disclosure;

FIGS. 10A and 10B are opposite side perspective views of the cable-operated drive mechanism of FIG. 9 with a housing removed for clarity of internal components;

FIG. 11 is an exploded view of the cable-operated drive mechanism of FIG. 9;

FIG. 12A is a view looking generally along the arrow 12A of FIG. 10A;

FIG. 12B is a view looking generally along the arrow 12B of FIG. 10B;

FIG. 13 is a perspective view of the cable-operated drive mechanism of FIG. 9 illustrating a housing thereof configured in accordance with another aspect of the disclosure;

FIG. 13A is a perspective view of the cable-operated drive mechanism of FIG. 9 illustrating a housing thereof configured in accordance with yet another aspect of the disclosure;

FIG. 13B is a partial side view of FIG. 13A showing a position sensor configured for monitoring one drum of a dual drum configuration, in accordance with an illustrative embodiment;

FIGS. 14 and 14A are opposite side perspective views of a cable-operated drive mechanism configured in accordance with another aspect of the disclosure;

FIG. 15 is an exploded view of the cable-operated drive mechanism of FIGS. 14 and 14A;

FIG. 16 is a view similar to FIG. 14 with a housing removed for clarity of internal components;

FIG. 17 illustrates a flow diagram of a method of constructing a cable-operated drive mechanism for a powered motor vehicle sliding closure panel in accordance with another aspect of the disclosure;

FIG. 18 is a schematic side view of a cable-operated drive mechanism configured in accordance with another aspect of the disclosure shown assembled beneath a floor board of a motor vehicle;

FIG. 19 is a schematic top view of the cable-operated drive mechanism configured in accordance with another aspect of the disclosure shown assembled within a sliding door of a motor vehicle;

FIG. 20 is a schematic side view of the cable-operated drive mechanism of FIG. 19;

FIG. 21 is a schematic perspective view of a cable-operated drive mechanism configured in accordance with another aspect of the disclosure;

FIG. 22 is a view similar to FIG. 21 of a cable-operated drive mechanism configured in accordance with another aspect of the disclosure;

FIG. 23 is a flow diagram illustrating a method of minimizing the axial height of a cable-operated drive mechanism for a powered motor vehicle sliding closure panel in accordance with another aspect of the disclosure;

FIG. 24 shows a block diagram of an exemplary drive mechanism control system in accordance with another aspect of the disclosure;

FIGS. 25-27 show an example powered drive mechanism of the drive mechanism control system in accordance with another aspect of the disclosure;

FIGS. 27 and 28 show an example target of the position sensor assembly in accordance with another aspect of the disclosure;

FIGS. 29A-29B show a coil and induction sensor circuitry unit of the position sensor assembly on a sensor printed circuit board in accordance with another aspect of the disclosure;

FIGS. 30-33 show rotation of the example target relative to the coil as the cable drum is rotated in accordance with another aspect of the disclosure; and

FIGS. 34 and 35 illustrate steps of a method of operating a drive mechanism control system in accordance with another aspect of the disclosure.

### DETAILED DESCRIPTION OF EXAMPLE EMBODIMENTS

An example embodiment of a position sensor assembly used for a motor vehicle sliding closure panel, for example, will now be described more fully with reference to the accompanying drawings. To this end, an example embodiment of a drive mechanism control system is also provided so that this disclosure will be thorough, and will fully convey its intended scope to those who are skilled in the art. Accordingly, numerous specific details are set forth such as examples of specific components, devices, and methods, to provide a thorough understanding of a particular embodiment of the present disclosure. However, it will be apparent to those skilled in the art that specific details need not be employed, that the example embodiments may be embodied in many different forms, and that the example embodiments should not be construed to limit the scope of the present disclosure. In some parts of the example embodiments, well-known processes, well-known device structures, and well-known technologies are not described in detail.

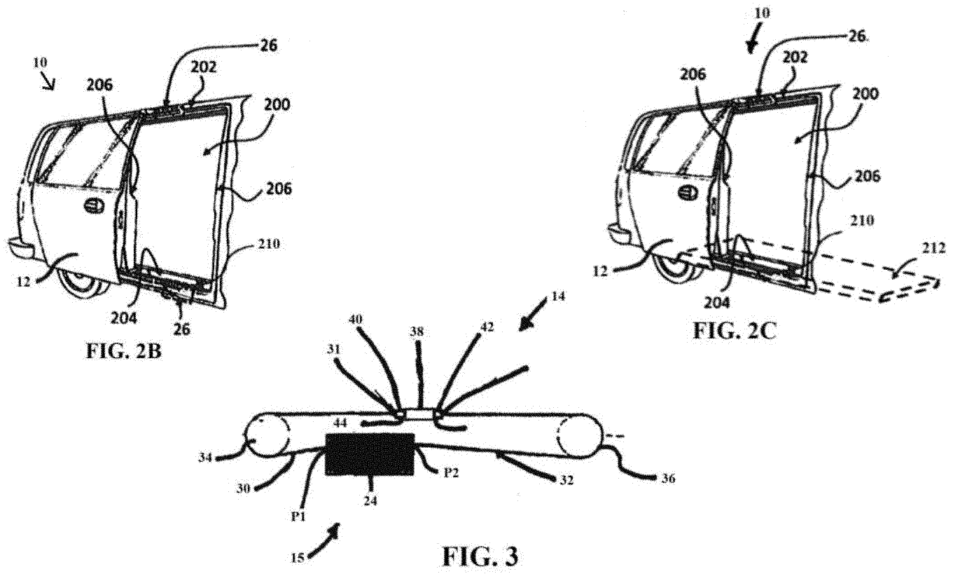

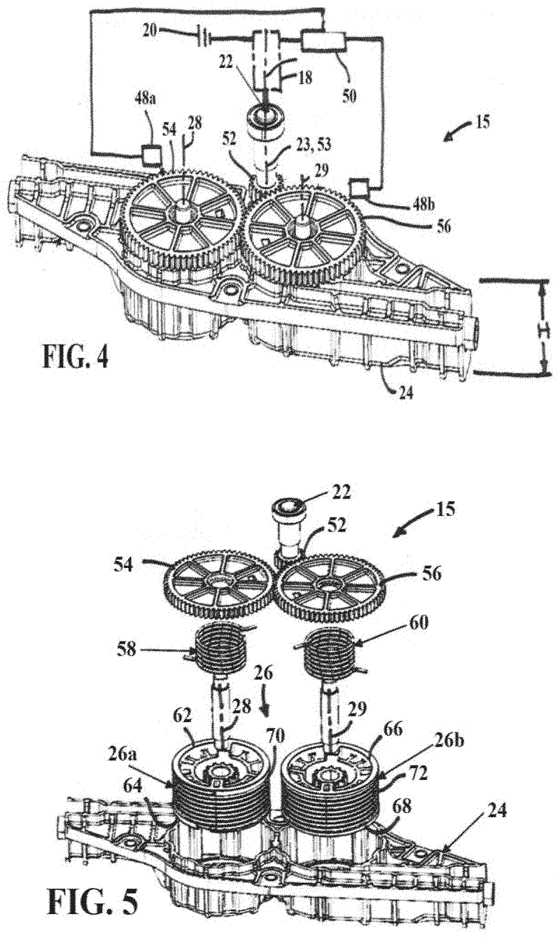

Reference is made to FIGS. 2-2A, which show a portion of a motor vehicle 10 including a motor vehicle sliding closure panel, also referred to as sliding closure panel assembly, shown, by way of example and without limitation as a sliding door 12, having a sliding door drive assembly, generally shown at 14 (FIG. 3), including a cable-operated drive mechanism 15 (FIG. 3) constructed in accordance with an aspect of the disclosure. The sliding door drive assembly 14 is mounted to the motor vehicle 10, such as beneath a floor board 16 (FIG. 2A) or within a quarter panel 17 (FIG. 2) thereof, by way of example and without limitation, and is operatively connected to the sliding door 12 for selective (intended hereafter to mean intentionally actuated or intentionally moved) movement between a closed state (FIG. 2) and an open state (FIG. 2A). As shown in FIG. 4, the sliding door drive assembly 14 includes a motor 18 that is electrically connected to an electric energy source, schematically represented at 20. It is contemplated that the motor 18 can use electric energy that is provided from a source known to be commonly provided in a motor vehicle, including a vehicle battery or from a generator, by way of example and without limitation. The motor 18 is preferably bidirectional, allowing for direct, selectively actuated rotation of an output shaft 22 in opposite rotational directions.

The cable-operated drive mechanism 15 includes a housing 24, shown with a cover removed for clarity of internal components, with a cable drum mechanism 26 supported in the housing 24. The cable drum mechanism 26 includes a first cable drum 26a supported for rotation in opposite first and second directions about a first drum axis 28 in response to rotation of the output shaft 22, and a second cable drum 26b supported for rotation in opposite first and second directions about a second drum axis 29 in response to rotation of the output shaft 22. As shown schematically in FIG. 3, a first cable 30 is coupled to the first cable drum 26a, wherein the first cable 30 extends away from the first cable drum 26a to a first end 31 configured for operable attachment to the motor vehicle sliding closure panel 12. The first cable 30 is configured to wind about the first cable drum 26a in response to the first cable drum 26a rotating in the first direction and to unwind from the first cable drum 26a in response to the first cable drum 26a rotating in the second direction. A second cable 32 is coupled to the second cable drum 26b, wherein the second cable 32 extends away from the second cable drum 26b to a second end 33 configured for operable attachment to the motor vehicle sliding closure panel 12. The second cable 32 is configured to unwind from the second cable drum 26b in response to the second cable drum 26b rotating in the first direction and to wind about the second cable drum 26b in response to the second cable drum 26b rotating in the second direction. The first drum axis 28 and the second drum axis 29 are laterally spaced from one another, and are shown as being substantially parallel or parallel with one another, thereby allowing the cable-operated drive mechanism 15 to be compact, particularly in height (height herein is a distance extending along the direction of first and second drum axes 28, 29) while remaining robust, durable, lightweight and economical in manufacture, assembly, and in use.

Referring to FIG. 3, the first cable 30 extends through a first cable port P1 of housing 24 about a front pulley, also referred to as first pulley 34, whereafter the first cable 30 is redirected back toward and into coupled relation with the sliding door 12. The second cable 32 extends through a second cable port P2 of housing 24 about a rear pulley, also referred to as second pulley 36, whereafter the second cable 32 is redirected back toward and into coupled relation with the sliding door 12. The first cable port P1 and the second cable port P2 can be configured in substantially coaxial or purely coaxial relation with one another, though shown offset, as desired. The first 30 cable and second cable 32 each have their respective ends 31, 33 fixedly secured to a center hinge, also referred to as mount or slide member 38, which is fixedly secured to the sliding door 12. Concurrent rotation of the first and second cable drums 26a, 26b winds one of the first cable 30 and second cable 32 and, at the same time, unwinds the other of the first cable 30 and second cable 32. Accordingly, first cable 30 is configured to wind about the first cable drum 26a in response to the first cable drum 26a rotating in a first direction and second cable 32 is configured to unwind from the second cable drum 26b in response to the second cable drum 26b rotating in the first direction, and likewise, first cable 30 is configured to unwind from the first cable drum 26a in response to the first cable drum 26a rotating in a second direction and second cable 32 is configured to wind about the second cable drum 26b in response to the second cable drum 26b rotating in the second direction.

The slide member 38 includes a forward cable terminal 40 and a rearward cable terminal 42 for securing the respective ends 31, 33 of first cable 30 and second cable 32 thereto. The forward cable terminal 40 and rearward cable terminal 42 can include respective forward and rearward cable tensioners 44, 46.

Referring to FIG. 4, at least one position sensor, and preferably a pair of position sensors, generally indicated at 48a, 48b, can be mounted within or to the housing 24 for indicating the rotational position of at least one, and preferably both of the first and second cable drums 26a, 26b. The position sensors 48a, 48b are a very high resolution position sensors and can be provided including a sensor that senses the orientation of a magnet (not shown), which is fixedly secured to the first cable drum 26a and second cable drum 26b for rotation therewith, as will be understood by one possessing ordinary skill in the art. The position sensors 48a, 48b detect the absolute position of the sliding door 12 from information provided by both the first and second cable drums 26a, 26b, with the position sensors 48a, 48b shown as being in operable communication with a controller 50. The controllers 50 are configured in operable communication with the motor 18, thereby being able to regulate energization and de-energization of the motor 18, as desired. An advantage of arranging position sensors 48a, 48b to detect the position of each drum 26a, 26b is that any slack within the first cable 30 and/or second cable 32 can be detected. Thus, the information provided by the separate sensors 48a, 48b to the controller 50 allows the controller 50 to determine how much slack may need to be taken up within one or both the first cable 30 and/or second cable 32 prior to movement of the sliding door 12 being initiated. By knowing how much slack needs to be taken up within one or both the first cable 30 and second cable 32, an optimal duty cycle can be produced, which can allow the motor 18 to be driven while under a minimal load (no load being exerted by the sliding door 12 on the motor 18 due to the sliding door 12 not being moved) at a high speed during a slack take-up phase, thereby allowing the slack to be taken up quickly and the reaction time to start moving the sliding door 12 to be minimized. Further yet, during the slack take-up phase, obstacle reversal algorithms which are triggered upon the detection by a sensor that an obstacle is in the path of the sliding door can be temporarily disabled. The temporary disabling of the obstacle reversal algorithms eliminates the potential for a false obstacle reversal signal, which may prove to be particularly beneficial as the slack in the cable system is increased over the life of the motor vehicle 10. It is to be understood that although beneficial to have sensors 48a, 48b for each drum 26a, 26b, a single sensor 48a or 48b could be used to detect the absolute position of the sliding door 12.

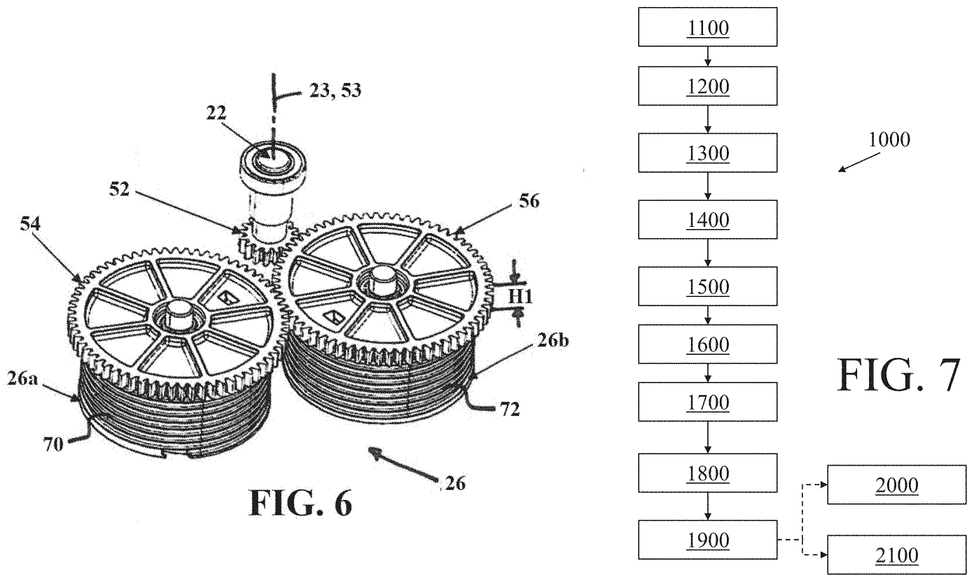

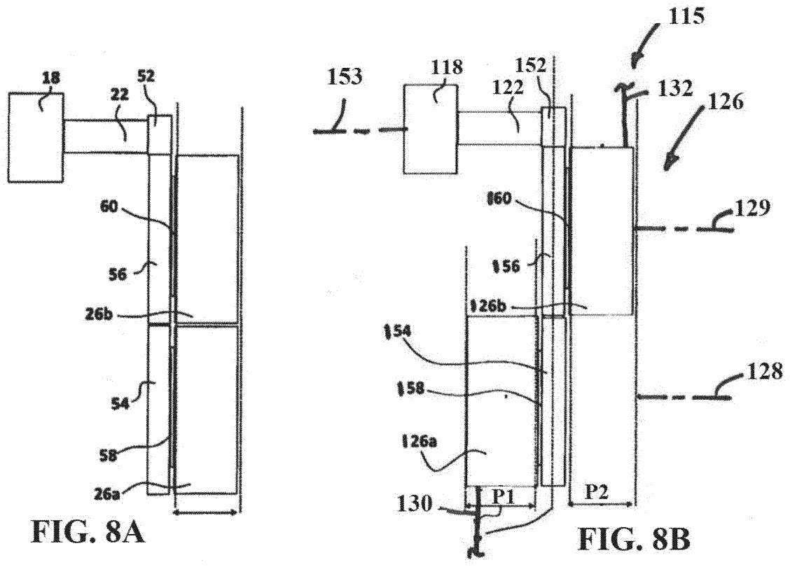

In FIGS. 4 and 6, output shaft 22 of motor 18 is illustrated as driving a drive member, shown in a non-limiting embodiment as a spur gear 52 fixed directly with output shaft 22, by way of example and without limitation. A first driven member 54 is configured in operable communication with the first cable drum 26a, such as being fixed directly thereto, or being coupled thereto via an intervening first spring member, such as a first torsion spring member 58 (FIG. 8), by way of example and without limitation, and a second driven member 56 is configured in operable communication with the second cable drum 26b, such as being fixed directly thereto, or being coupled thereto via an intervening second spring member, such as a second torsion spring member 60 (FIG. 8), by way of example and without limitation. As such, first and second torsion spring members 58, 60 transmit a torque between respective first and second driven members 54, 56 and respective first and second cable drums 26a, 26b. Further yet, the first spring member 58 imparts a tensile force on the first cable 30 and the second spring member 60 imparts a tensile force on the second cable 32. The drive member 52 is configured in operable communication with the first driven member 54 and the second driven member 56 to cause concurrent rotation of the first cable drum 26a about the first drum axis 28 and the second cable drum 26b about the second drum axis 29 in response to selective energization of the motor 18. It is to be understood that the drive member 52 and the first and second driven members 54, 56 can be provided as toothed gears, with the drive member 52 being configured in meshed relation with one of the first and second driven members 54, 56. In the non-limiting embodiment illustrated, the drive member 52 is a toothed spur gear fixed to output shaft 22 for conjoint rotation with output shaft 22 about a drive gear axis, also referred to as spur gear axis 53, about which spur gear 52 rotates. Spur gear axis 53 is shown as extending parallel to first and second drum axes 28, 29 and coaxially with a motor shaft and output shaft axis 23. The drive member 52 is shown, by way of example and without limitation, as being in direct driving engagement with driven member 56, though it is to be understood that drive member 52 could be arranged in direct driving engagement with driven member 54 or both driven member 54 and driven member 56. Further yet, it is contemplated herein that drive member 54 could be arranged to drive the driven members 54, 56 via a belt drive, with a belt (not shown) being in direct engagement with one or both driven members 54, 56.

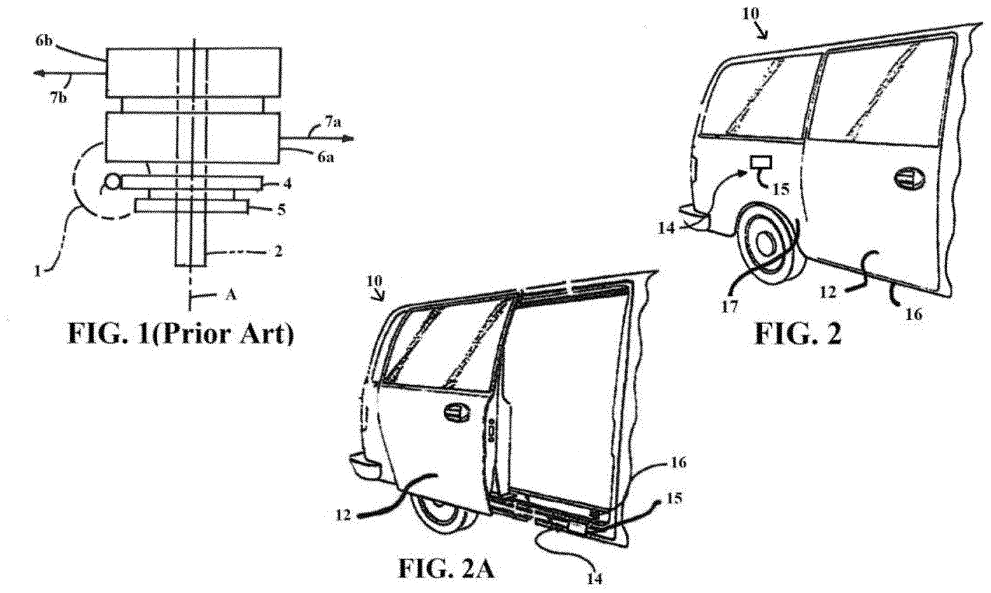

The first cable drum 26a and the second cable drum 26b are substantially coplanar (meaning they could be slightly offset and not purely planar) or coplanar. As such, opposite sides, also referred to as faces 62, 64 of first cable drum 26a can be coplanar with respective opposite sides, also referred to as faces 66, 68 of second cable drum 26b. Accordingly, first cable drum 26a and the second cable drum 26b are not stacked vertically with one another, but rather, are spaced in side-by-side relation with one another, thereby reducing by up to ½ the total height H (FIG. 4) of the cable drum mechanism 26 relative to that shown in FIG. 1, thereby greatly enhancing the ability to locate the cable-operated drive mechanism 15 beneath the floor board 16, which is otherwise not possible with the mechanism of FIG. 1.

First and second driven members 54, 56 have respective gear teeth, shown as spur gear teeth 54a, 56a configured in meshed engagement with one another. Accordingly, first driven member 54 and second driven members 56 are caused to rotate concurrently with one another upon one of the first and second driven members 54, 56 being driven. In the illustrated embodiment, drive member 52 is configured in meshed engagement with second driven member 56, but is spaced from first driven member 54, and thus, only a single meshed engagement is provided between drive member 52 and first and second driven members 54, 56, which ultimately results in reduced friction and potential binding as compared to if drive member 52 were in meshed engagement with both first and second driven members 54, 56. Accordingly, operational efficiencies are recognized. To minimized the height H discussed above, as shown in FIG. 6, drive member 52 and first and second driven members 54, 56 can be provided having the same height (H1).

To further enhance the functional reliability and repeatability of cable-operated drive mechanism 15, the first and second cable drums 26a, 26b can be provided having a respective first helical groove 70 and a second helical groove 72. The first cable 30 is wrapped in the first helical groove 70 in non-overlapping relation with itself and the second cable 32 is wrapped in the second helical groove 72 in non-overlapping relation with itself. As such, with the first and second cables 30, 32 not being wrapped in overlapping relation with themselves, the first and second cables 30, 32 are free from compressive forces that might otherwise cause them to become flattened and/or slip relative to themselves, and thus, the operation performance of the cable-operated drive mechanism 15 is optimized. Further yet, it is to be recognized that with the height H being significantly reduced compared to that of the mechanism of FIG. 1, the height of the individual first and second cable drums 26a, 26b can be increased to allow for an increased lineal length of the first and second cables 30, 32 to be wrapped within the first and second helical grooves 70, 72 without being overlapped on themselves, while still resulting in a significantly reduced height H relative to the mechanism of FIG. 1.

In accordance with a further aspect of the disclosure, as diagrammatically shown in FIG. 7, a method 1000 of minimizing the axial height H of a cable-operated drive mechanism 15 for a powered motor vehicle sliding closure panel 12 is provided. The method includes a step 1100 of providing a housing 24; a step 1200 of providing a motor 18 configured to rotate an output shaft 22 in opposite directions; a step 1300 of supporting a cable drum mechanism 26 in the housing 24 and providing the cable drum mechanism 26 including a first cable drum 26a supported for rotation in opposite first and second directions about a first drum axis 28 in response to rotation of the output shaft 22 and a second cable drum 26b supported for rotation in opposite first and second directions about a second drum axis 29 in response to rotation of the output shaft 22. Further, a step 1400 of providing a first cable 30 configured to wind about the first cable drum 26a in response to the first cable drum 26a rotating in the first direction and to unwind from the first cable drum 26a in response to the first cable drum 26a rotating in the second direction. Further, a step 1500 of providing a second cable 32 configured to unwind from the second cable drum 26b in response to the second cable drum 26b rotating in the first direction and to wind about the second cable drum 26b in response to the second cable drum 26b rotating in the second direction. Further, a step 1600 of arranging the first drum axis 28 and the second drum axis 29 in laterally spaced relation from one another, and preferably in parallel relation with one another. Further, a step 1700 of arranging the first cable drum 26a and the second cable drum 26b in coplanar relation with one another, such that a plane P (FIG. 7) extending transversely to the first and second drum axes 28, 29 extends between opposite substantially planar faces 62, 64 of the first cable drum 26a, 126a and the second cable drum 26b, 126b. Further yet, a step 1800 of configuring a first driven member 54 in operable communication with the first cable drum 26a and configuring a second driven member 56 in operable communication with the second cable drum 26b. Further yet, a step 1900 of configuring a drive member 52 for rotation in response to rotation of the output shaft 22 to rotate the first driven member 54 and the second driven member 56 without a gear reduction between the drive member 52 and the first driven member 54 and the second driven member 56.

The method can further include a step 2000 of configuring the drive member 52 in driving engagement with one of the first driven member 54 and the second driven member 56 and in spaced relation from the other of the first driven member 54 and the second driven member 56 to cause concurrent rotation of the first cable drum 26a about the first axis 28 and the second cable drum 26b about the second axis 29 in response to selective energization of the motor 18.

The method can further include a step 2100 of configuring the first driven member 54 and the second driven member 56 in driving engagement with one another, such as in meshed, driving engagement with one another.

The method can further include operably coupling the first driven member 54 with the first cable drum 26a with a first spring member 58 and operably coupling the second driven member 56 with the second cable drum 26b with a second spring member 60.

Now referring to FIG. 2B, there is illustrated a vehicle 10 including an opening 200 for allowing ingress and egress into an interior of the vehicle 10, the opening 200 having an upper perimeter 202 defined by an upper portion of a vehicle frame, a lower perimeter 204 defined by lower opposite portion of the vehicle frame, and opposite side perimeters 206 defined by opposite side portions of the vehicle frame, a closure panel 12 movable between an open position and a closed position and configured close off the opening 200, a cable-operated drive mechanism 26 coupled to the closure panel 12 via at least one cable 30, 32, the cable-operated drive mechanism 26 having two drums 26a, 26b spaced laterally apart from each other and secured to the vehicle frame 208 at either a position below the lower perimeter 204 of the opening 200 or above the upper perimeter 202 of the opening. The lower perimeter 204 may be defined by a floor board 210, and the cable-operated drive mechanism 26 is provided at a position below the floor board 210. In accordance with another aspect and with reference to FIG. 2C, the vehicle 10 may be an electric vehicle, and the space below the lower perimeter 204 is occupied by a battery 212 configured to supply energy to drive an electrical motor of the vehicle 10 for providing propulsion to the vehicle 10, and the cable-operated drive mechanism 26 is provided at a position above the upper perimeter 202. As a result, the battery 212 may be extended to the fullest side extents of the vehicle 10 to maximize the space provided to the battery 212, without having to reduce the size of the battery to accommodate the space required for cable-operated drive mechanism 26, now being able to be provided about the opening 200 due to its compact height H.

FIG. 8A is a schematic side view of the cable-operated drive mechanism of FIG. 4 showing the cable drums arranged in a common plane. Accordingly, the first cable drum 26a and said second cable drum 26b are coplanar.

Now referring to FIG. 8B, there is illustrated a schematic side view of a direct drive cable drum mechanism 126 constructed in accordance with another aspect of the disclosure, wherein the same reference numerals as used above, offset by a factor of 100, are used to identify like features. The cable drum mechanism 126 has a first cable drum 126a and the second cable drum 126b, but unlike cable drum mechanism 26, the first cable drum 126a and the second cable drum 126b are non-overlapping, and thus, are not coplanar (as discussed above for cable drums 26a, 26b). Rather, first cable drum 126a and second cable drum 126b, although being axially offset from one another, are arranged for rotation within axially offset, non-parallel planes P1, P2. Otherwise, direct drive cable drum mechanism 126 is the same as discussed above for direct drive cable drum mechanism 26, and thus, further discussion thereof is unnecessary for the skilled artisan to understand the construction and operation thereof.

There is illustrated a brushless low profiled “pancake” style brushless motor 118 provided in an overlapping arrangement with only one of the cable drums e.g. 126a for providing an overall low cross-width profiled direct drive cable drum mechanism 126.

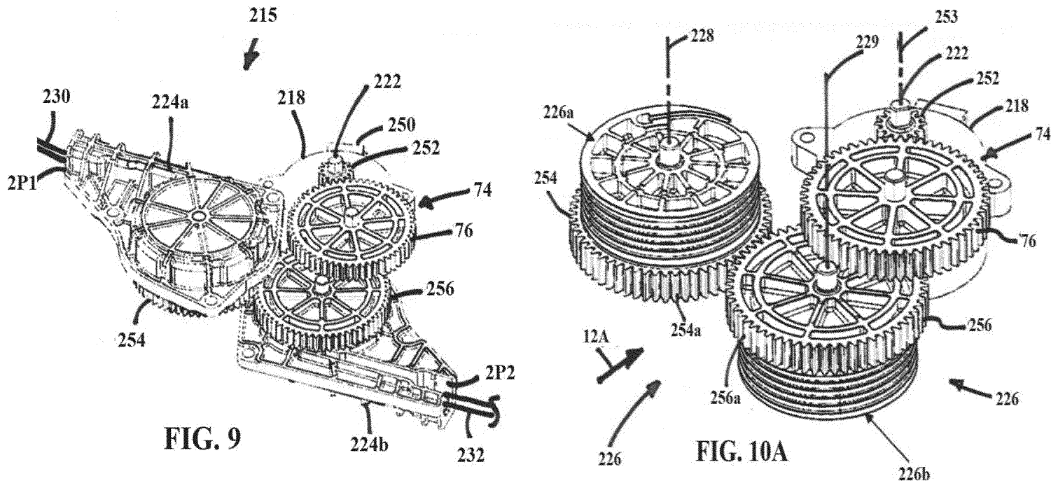

Now referring to FIG. 9, there is illustrated a perspective view of a cable-operated drive mechanism 215 having a cable drum mechanism 226 constructed in accordance with another aspect of the disclosure, wherein the same reference numerals as used above, offset by a factor of 200, are used to identify like features.

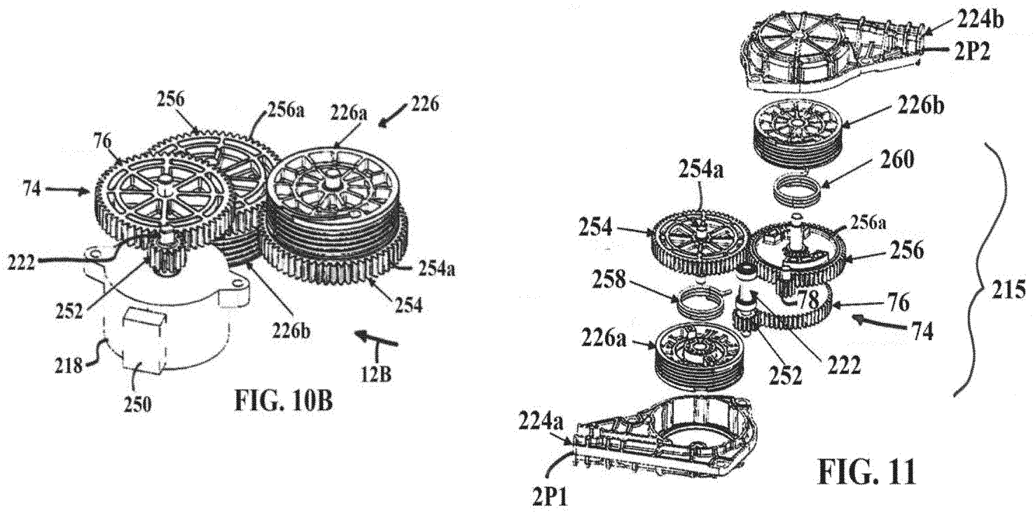

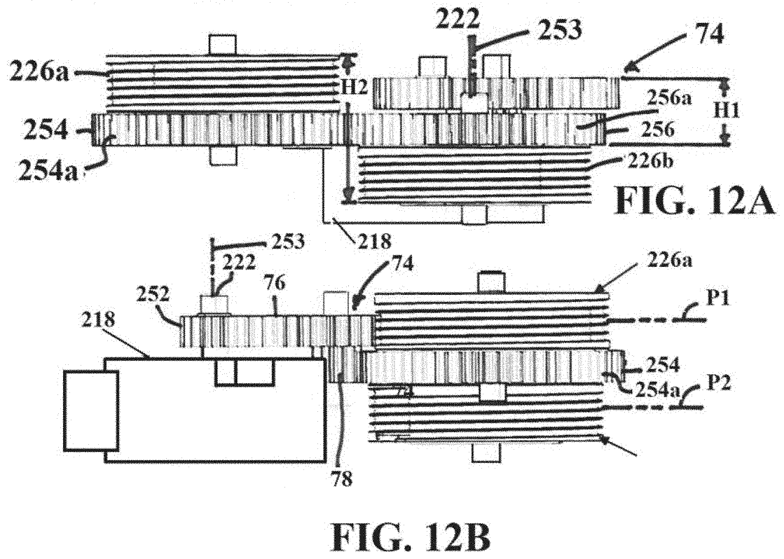

As shown in FIGS. 10A and 10B, the cable drum mechanism 226 has a first cable drum 226a and a second cable drum 226b, and like cable drum mechanism 126, the first cable drum 226a and the second cable drum 226b are not coplanar, and thus, are similarly arranged for rotation within axially offset, non-parallel planes P1, P2 (FIG. 12B).

The first cable drum 226a is supported for rotation in opposite first and second directions about a first drum axis 228 in response to rotation of an output shaft 222 of a motor 218, and the second cable drum 226b supported for rotation in opposite first and second directions about a second drum axis 229 in response to rotation of the output shaft 222. As discussed above with reference to FIG. 3, a first cable 230 is coupled to the first cable drum 226a to wind about the first cable drum 226a in response to the first cable drum 226a rotating in the first direction and to unwind from the first cable drum 226a in response to the first cable drum 226a rotating in the second direction and a second cable 232 is coupled to the second cable drum 226b to unwind from the second cable drum 226b in response to the second cable drum 226b rotating in the first direction and to wind about the second cable drum 226b in response to the second cable drum 226b rotating in the second direction. The first drum axis 228 and the second drum axis 229 are laterally spaced from one another, and are shown as being substantially parallel or parallel with one another, thereby allowing the cable-operated drive mechanism 215 to be compact, particularly in height, as discussed above, while remaining robust, durable, lightweight and economical in manufacture, assembly, and in use.

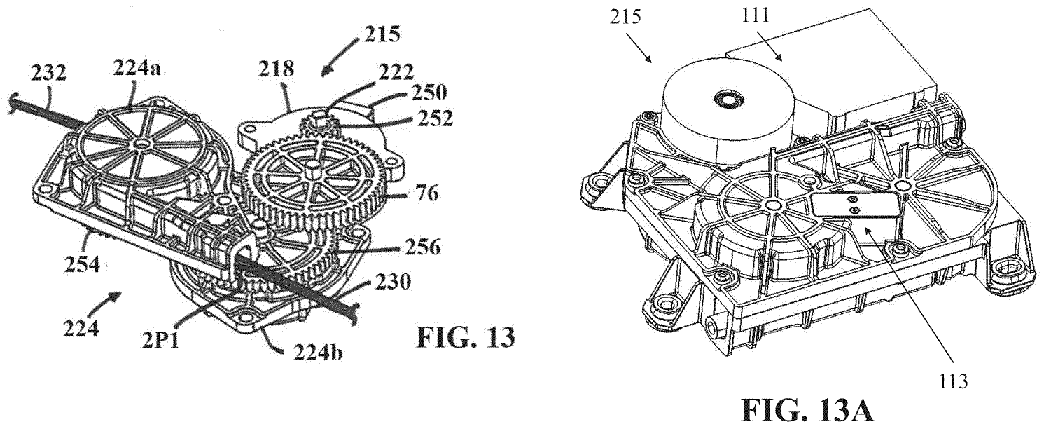

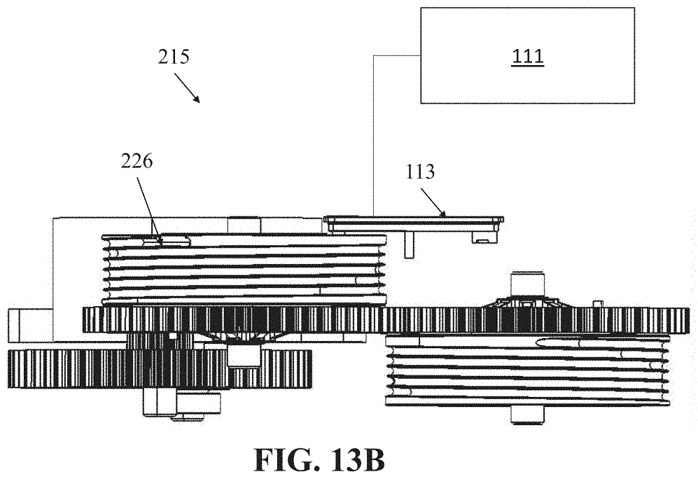

Motor 218, as discussed above for motor 18, can use electric energy that is provided from a source known to be commonly provided in a motor vehicle, including a vehicle battery or from a generator, by way of example and without limitation. The motor 218 is preferably bidirectional, allowing for direct, selectively actuated rotation of output shaft 222 in opposite rotational directions, and can be provided as a brushless, direct current (BLDC) motor. An ECU (Electronic Control Unit) 111 for controlling the brushless motor (e.g. executing Field Oriented Control algorithms) may be provided within the housing 224, and for example in a co-planar or overlapping position, as shown in FIG. 12A. ECU (Electronic Control Unit) 111 may further be provided with position sensors 113, for example directly mounted on a PCB of the ECU 111, or one an independent remote board as shown in FIGS. 13A and 13B for example, for directly monitoring the position of either the adjacent one of the first and second cable drums 226a, 226b for ascertaining direct positional information associated with the sliding door, and/or for determining position information of the first and second driven members 254, 256 for ascertaining direct positional information associated with the motor 218. Position sensor 113 may be a hall sensor, an induction sensor type e.g. a coiled based sensor for example and may be mounted to a printed circuit board separate and distinct from the motor control circuit board 111. Sensor 113 may be configured as a proximity sensor to detect the presence of a target, such as the drum 226a, b, or a target fixed to the drum 226a,b which may be a metallic object for example. Proximity sensor 113, such as when configured as an induction sensor, may generate a magnetic field for interaction by the drum 226a, b and/or target fixed to the drum 226a, b, and detect a change in the generated magnetic field in response to the drum 226a, b and/or target or object fixed to the drum 226a, b moving through the generated magnetic field.

The at least one position sensor 113, as discussed above for position sensor 48, can be mounted within a housing 224 or to motor 218 for indicating the rotational position of at least one of the first and second cable drums 226a, 226b, wherein the position sensor 113 can be configured in operable communication with a controller 250 (e.g., ECU 111). The controller 250 is configured in operable communication with the motor 218, thereby being able to regulate energization and de-energization of the motor 218, as desired, as discussed above for controller 50.

The output shaft 222 of motor 218 is illustrated as driving a drive member, shown in a non-limiting embodiment as a spur gear 252 fixed directly with output shaft 222, by way of example and without limitation. A first driven member 254 is coupled with the first cable drum 226a, such as via an intervening first spring member, such as a first torsion spring member 258 (FIG. 11), by way of example and without limitation, and a second driven member 256 is coupled with the second cable drum 226b, such as via an intervening second spring member, such as a second torsion spring member 260, by way of example and without limitation. As such, first and second torsion spring members 258, 260 transmit a torque between respective first and second driven members 254, 256 and respective first and second cable drums 226a, 226b. Further yet, the first spring member 258 imparts a tensile force on the first cable 230 and the second spring member 260 imparts a tensile force on the second cable 232. The drive member 252 is configured in operable communication with the first driven member 254 to cause concurrent rotation of the first cable drum 226a about the first drum axis 228, which in turn, via meshed engagement of first driven member 254 with second driven member 256, causes concurrent rotation of second cable drum 226b about the second drum axis 229 in response to selective energization of the motor 218. The presented disclosure recognizes that the drive member 252 may be meshed in engagement with both the first and second driven members 254, 256 (for example via output gear 78, and that is output gear 78 is meshed with both the first and second driven members 254, 256) while the drive member 252 and the first and second driven members 254, 256 are not in meshed engagement with one another. It is to be understood that the drive member 252 and the first and second driven members 254, 256 can be provided as toothed gears, with a geartrain 74 being disposed between the drive member 252 and one of the first and second driven members 254, 256, shown as the second driven member 256, by way of example and without limitation. In the non-limiting embodiment illustrated, the drive member 252 is a toothed spur gear fixed to output shaft 222 for conjoint rotation with output shaft 222 about a drive gear axis, also referred to as spur gear axis 253, about which spur gear 252 rotates. Spur gear axis 253 is shown as extending parallel to first and second drum axes 228, 229.

First and second driven members 254, 256 have respective gear teeth, shown as spur gear teeth 254a, 256a configured in meshed engagement with one another. Accordingly, first driven member 254 and second driven member 256 are caused to rotate concurrently with one another upon one of the first and second driven members 254, 256 being driven. In the illustrated embodiment, drive member 252 is configured in meshed engagement with geartrain 74, with geartrain being in meshed engagement with second driven member 256, but is spaced from first driven member 254, and thus, only a single meshed engagement is provided between geartrain 74 and first and second driven members 254, 256, which ultimately results in reduced friction and potential binding as compared to if geartrain 74 were in meshed engagement with both first and second driven members 254, 256. Accordingly, operational efficiencies are recognized. To minimized the height H discussed above, as shown in FIG. 12A, drive member 252 and first and second driven members 254, 256 can be provided having a height (H1) confined within a height H2 extending between opposite faces of first cable drum 226a and second cable drum 226b. As illustratively shown in FIGS. 12A and 12B, the first and second cable drums 226a, 226b are in a non-planar relation, and for example their outer circumferences are provided in a non-overlapping manner. Furthermore, an offset between the opposite faces of the first and second cable drums 226a, 226b may be provided for defining a separation between the first and second cable drums 226a, 226b for accommodating the first and second driven members 254, 256.

Geartrain 74 provides a gear reduction between drive member 252 and second driven member 256, which results in a speed reduction, torque multiplication output from motor 218 to first and second driven members 254, 256 and first and second cable drums 226a, 226b. Geartrain 74 includes an input gear 76 and an output gear 78, with input gear 76 being in meshed engagement with drive member 252 and output gear 76 being in meshed engagement with second driven member 256. Input gear 76 has a relatively large diameter and number of teeth relative to drive member 252 and relative to output gear 78, wherein the relative diameters and numbers of teeth can be provided to produce the speed reduction and torque multiplication desired.

With the first and second cable drums 226a, 226b being in axially offset planes P1, P2, output cable guides, such provided by cable ports of housing, shown as separate cable ports 2P1, 2P2 within separate portions of housing 224, namely, housings 224a, 224b for each of the first and second cable drums 226a, 226b, by way of example and without limitation, can be arranged in any orientation and facing any direction desired to allow the housing size to be optimally minimized and the first and second cables 230, 232 to be routed as desired. As a non-limiting example, FIG. 13 shows housings 224a, 224b oriented such that cable ports 2P1 (not in view due to being beneath housing 224a), 2P2 are facing opposite directions to that of FIG. 9 simply by reorienting cable housings 224a, 224b accordingly. As such, cables 230, 232 extend away from cable operated drive mechanism in opposite directions to that of FIG. 9, thereby providing a more compact package size.

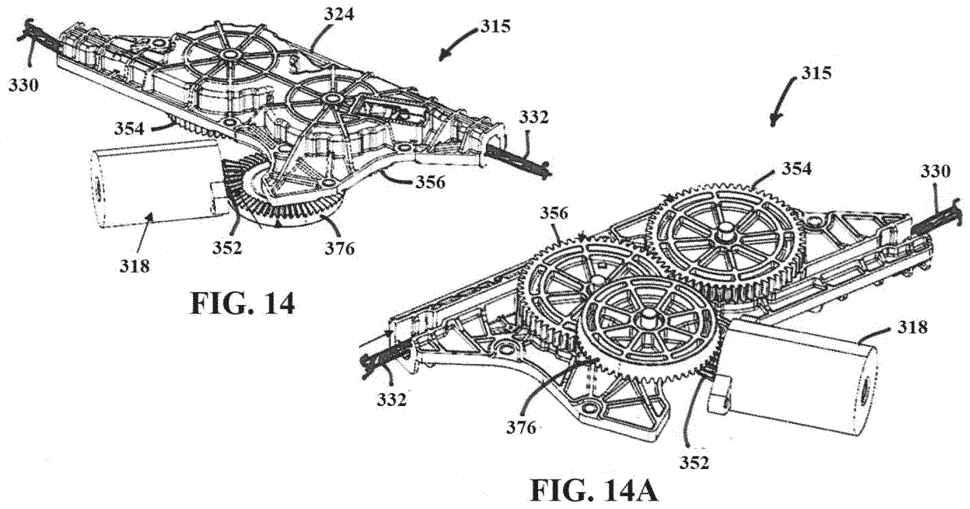

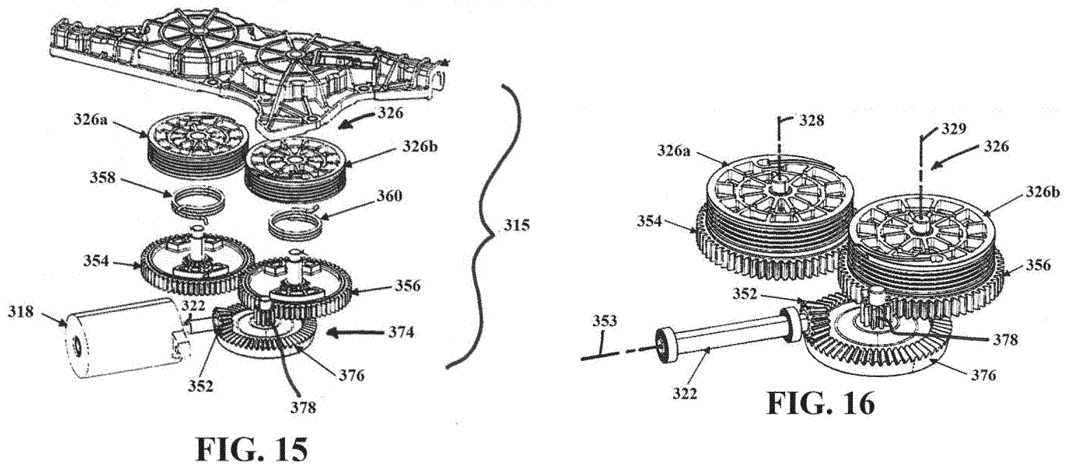

Now referring to FIGS. 14-15, there is illustrated a cable-operated drive mechanism 315 having a cable drum mechanism 326 constructed in accordance with another aspect of the disclosure, wherein the same reference numerals as used above, offset by a factor of 300, are used to identify like features.

Cable drum mechanism 326 has similarities to cable drum mechanism 26 in that it has, as shown in FIGS. 15 and 16, a first cable drum 326a and a second cable drum 326b arranged in planar relation with one another for rotation within axially aligned, parallel planes for controlled winding and unwinding of first and second cables 330, 332, respectively. Further yet, cable drum mechanism 326 has similarities to cable drum mechanism 226 in that it has a geartrain 374 being disposed between a drive member 352 and one of a first and second driven members 354, 356, wherein first and second driven members 354, 356, being coupled via spring members 358, 360 to first and second cable drums 326a, 326b, respectively, are as discussed above for first and second driven members 254, 256 and first and second cable drums 226a, 226b, and thus, further discussion thereof is unnecessary. However, geartrain 374 has differences that allow a reduced axial height package size for cable-operated drive mechanism 315, namely, having a bevel input gear 376 configured for meshed engagement with a bevel drive gear, also referred to as bevel drive member 352. Geartrain 374 further includes output gear 378, similar to output gear 278, configured for meshed engagement with one of the first and second driven members 354, 356, shown as second driven member 356, by way of example and without limitation. The bevel gears 352, 376 allow a motor 318, such as discussed above for motors 18, 218, to extend lengthwise parallel to the planes in which first and second driven members 354, 356 rotate, such that a motor shaft 322 extends along a drive shaft axis 353 that extends transversely to axes 328, 329 (FIG. 16) about which first and second driven members 354, 356 rotate. Accordingly the axially extending height (extending along the direction of axes 328, 329) of cable-operated drive mechanism 315 is minimized.

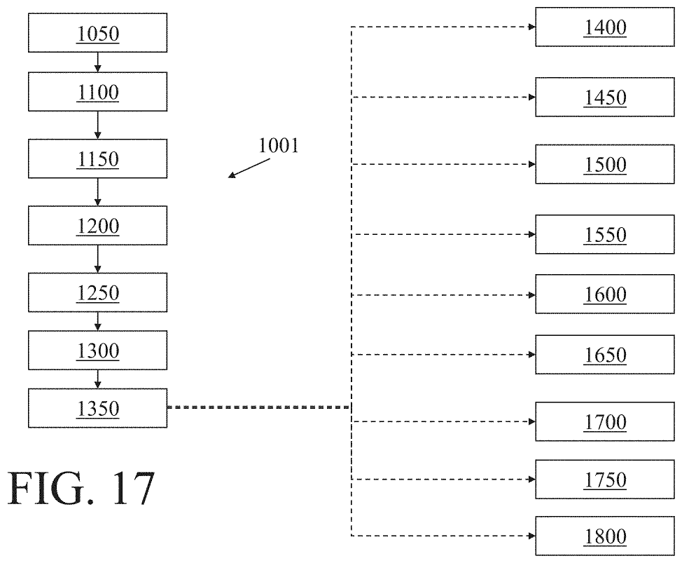

In accordance with another aspect of the disclosure, as shown in FIG. 17, a method 1000 of constructing a cable-operated drive mechanism 15, 115, 215, 315 for a powered motor vehicle sliding closure panel 12 is provided. The method includes a step 1050 of providing a housing 24, 124, 224, 324; a step 1100 of providing a motor 18, 118, 218, 318 configured to rotate an output shaft 22, 122, 222, 322 in opposite directions; a step 1150 of supporting a cable drum mechanism 26, 126, 226, 326 in the housing 24, 124, 224, 324 and providing the cable drum mechanism 26, 126, 226, 326 including a first cable drum 26a, 126a, 226a, 326a supported for rotation in opposite first and second directions about a first drum axis 28, 128, 228, 328 and a second cable drum 26b, 126b, 226b, 326b supported for rotation in opposite first and second directions about a second drum axis 29, 129, 229, 329; a step 1200 of providing a first cable 30, 130, 230, 330 configured to wind about the first cable drum 26a, 126a, 226a, 326a in response to the first cable drum 26a, 126a, 226a, 326a rotating in the first direction and to unwind from the first cable drum 26a, 126a, 226a, 326a in response to the first cable drum 26a, 126a, 226a, 326a rotating in the second direction and providing a second cable 32, 132, 232, 332 configured to unwind from the second cable drum 26b, 126b, 226b, 326b in response to the second cable drum 26b, 126b, 226b, 326b rotating in the first direction and to wind about the second cable drum 26b, 126b, 226b, 326b in response to the second cable drum 26b, 126b, 226b, 326b rotating in the second direction; a step 1250 of arranging the first drum axis 28, 128, 228, 328 and the second drum axis 29, 129, 229, 329 in laterally spaced, parallel relation with one another; a step 1300 of arranging a first driven member 54, 154, 254, 354 to rotate the first cable drum 26a, 126a, 226a, 326a in response to rotation of the first driven member 54, 154, 254, 354 and arranging a second driven member 56, 156, 256, 356 to rotate the second cable drum 26b, 126b, 226b, 326b in response to rotation of the second driven member 56, 156, 256, 356; and a step 1350 of configuring a drive member 52, 152, 252, 352 for rotation in response to rotation of the output shaft 22, 122, 222, 322 to rotate the first driven member 54, 154, 254, 354 and the second driven member 56, 156, 256, 356, wherein the first driven member 54, 154, 254, 354 and the second driven member 56, 156, 256, 356 are operably meshed to rotate respectively about the first drum axis 28, 128, 228, 328 and the second drum axis 29, 129, 229, 329 within a common plane with one another to cause concurrent rotation of the first cable drum 26a, 126a, 226a, 326a about the first axis 28, 128, 228, 328 and the second cable drum 26b, 126b, 226b, 326b about the second axis 29, 129, 229, 329 in response to selective energization of the motor 18, 118, 218, 318.

The method can also include a step 1400 of arranging the first cable drum 126a, 226a and the second cable drum 126b, 226b in non-planar relation with one another, as shown in FIGS. 12A and 12B.

The method can also include a step 1450 of arranging the first cable drum 126a, 226a on one side of the common plane in which the first driven member 154, 254 and the second driven member 156, 256 rotate, and arranging the second cable drum 126b, 226b on an opposite side of the common plane in which the first driven member 154, 254 and the second driven member 156, 256 rotate.

The method can also include a step 1500 of providing the drive member 52, 152, 252, the first driven member 54, 154, 254 and the second driven member 56, 156, 256 as spur gears.

The method can also include a step 1550 of configuring the drive member 52, 152, 252 to rotate about a drive member axis 53, 153, 253 and arranging the first drum axis 28, 128, 228, the second drum axis 29, 129, 229 and the drive member axis 53, 153, 253 in parallel relation with one another.

The method can also include a step 1600 of disposing a geartrain 74, 374 in meshed engagement with the drive member 252, 352 and at least one of the first driven member 254, 354 and the second driven member.

The method can also include a step 1650 of providing the geartrain including a bevel gear 376.

The method can also include a step 1700 of providing the geartrain including a spur gear 378.

The method can also include a step 1750 of arranging the bevel gear 376 in meshed engagement with the drive member 352.

The method can also include a step 1800 of arranging the output shaft 322 to extend along an output shaft axis 353 that extends obliquely or transversely to the first drum axis 328 and the second drum axis 329.

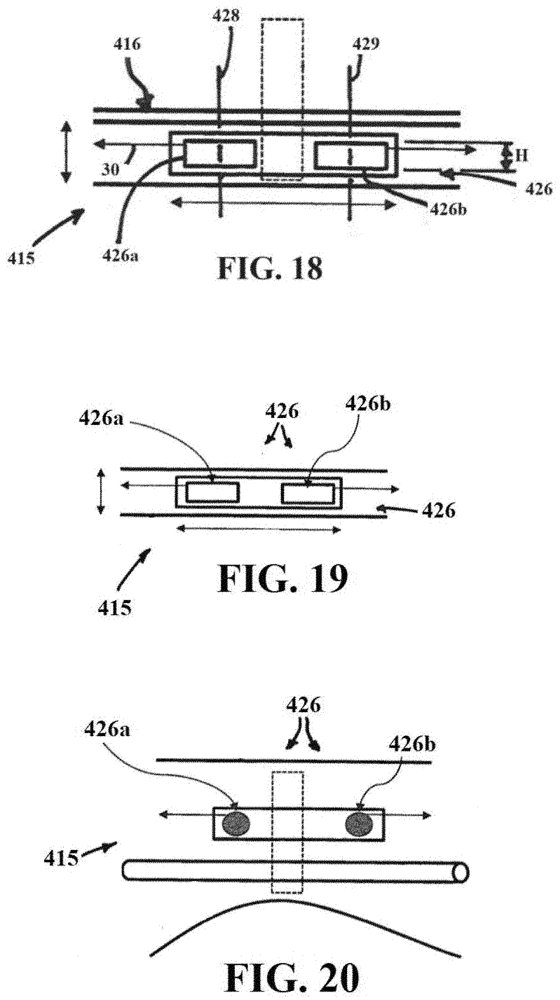

Now referring to FIG. 18, there is illustrated a schematic side view of a direct drive cable drum mechanism 426 constructed in accordance with another aspect of the disclosure, wherein the same reference numerals as used above, offset by a factor of 400, are used to identify like features.

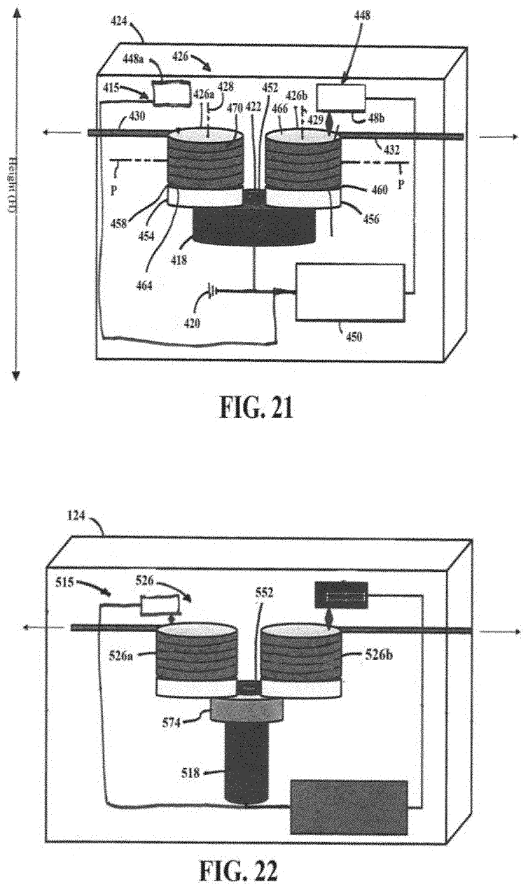

Referring to FIG. 21, at least one position sensor, and preferably a pair of position sensors, generally indicated at 448a, 448b, can be mounted within or to the housing 424 for indicating the rotational position of at least one, and preferably both of the first and second cable drums 426a, 426b. The position sensors 448 are provided as discussed above with regard to position sensors 48a, 48b to sense the orientation of a magnet (not shown), which is fixedly secured to the first and second cable drums 426a, 426b for rotation therewith, as will be understood by one possessing ordinary skill in the art. The position sensors 448a, 448b detects the absolute position of the sliding door 12 from knowing the positions of both the first and second cable drums 426a, 426b, with the position sensors 448a, 448b shown as being in operable communication with a controller 450. The controller 450 is configured in operable communication with the motor 418, thereby being able to regulate energization and de-energization of the motor 418, as desired, as discussed above for controller 50 and motor 18.

In FIG. 21, motor 418 is illustrated driving output shaft 422 and a drive member 452 fixed in operable communication with output shaft 422, such as being fixed directly thereto, by way of example and without limitation. A first driven member 454 is configured in operable communication with the first cable drum 426a, such as being fixed directly thereto, or via an intervening first spring member, such as a first torsion spring member 458, by way of example and without limitation, and a second driven member 456 is configured in operable communication with the second cable drum 426b, such as being fixed directly thereto, or via an intervening second spring member, such as a second torsion spring member 460, by way of example and without limitation. As such, first and second torsion spring members 458, 460 transmit a torque between respective first and second driven members 454, 456 and respective first and second cable drums 426a, 426b. Further yet, the first spring member 458 imparts a tensile force on the first cable 430 and the second spring member 460 imparts a tensile force on the second cable 432. The drive member 452 is configured in operable communication with the first driven member 454 and the second driven member 456 to cause concurrent rotation of the first cable drum 426a about the first drum axis 428 and the second cable drum 426b about the second drum axis 429 in response to selective energization of the motor 418. It is to be understood that the drive member 452 and the first and second driven members 454, 456 can be provided as toothed gears, with the drive member 452 being configured in meshed relation with first and second driven members 454, 456. It is to be further understood that drive member 452 can be otherwise configured for frictional engagement with first and second driven members 454, 456, such that first and second driven members 454, 456 are driven in response to rotation of drive member 452.

The first cable drum 426a and the second cable drum 426b are substantially coplanar (meaning they could be slightly offset and not purely planar) or coplanar. As such, opposite sides, also referred to as faces 462, 464 of first cable drum 426a can be coplanar with respective opposite sides, also referred to as faces 466, 468 of second cable drum 426b. Accordingly, first cable drum 426a and the second cable drum 426b are not stacked vertically with one another, but rather, are spaced laterally from one another, thereby reducing by up to ½ the total height H (FIG. 18) of the cable drum mechanism 426 relative to that shown in FIG. 1, thereby greatly enhancing the ability to locate the cable-operated drive mechanism 415 beneath the floor board 416, which is otherwise not possible with the mechanism of FIG. 1.

To further enhance the functional reliability and repeatability of cable-operated drive mechanism 415, the first and second cable drums 426a, 426b can be provided having a respective first helical groove 470 and a second helical groove 472. The first cable 430 is wrapped in the first helical groove 470 in non-overlapping relation with itself and the second cable 432 is wrapped in the second helical groove 472 in non-overlapping relation with itself. As such, with the first and second cables 430, 432 not being wrapped in overlapping relation with themselves, the first and second cables 430, 432 are free from compressive forces that might otherwise cause them to become flattened and/or slip relative to themselves, and thus, the operation performance of the cable-operated drive mechanism 415 is optimized. Further yet, it is to be recognized that with the height H being significantly reduced compared to that of the mechanism of FIG. 1, the height of the individual first and second cable drums 426a, 426b can be increased to allow for an increased lineal length of the first and second cables 430, 432 to be wrapped within the first and second helical grooves 470, 472 without being overlapped on themselves, while still resulting in a significantly reduced height H relative to the mechanism of FIG. 1.

In FIG. 22, a cable-operated drive mechanism 515 constructed in accordance with another aspect of the disclosure is illustrated, wherein the same reference numerals, offset by a factor of 500, are used to identify like features. Cable-operated drive mechanism 515 includes a cable drum mechanism 526 disposed in a housing 524, wherein cable drum mechanism 526 is substantially similar to cable drum mechanism 426, but further includes a gearbox, such as a planetary transmission/clutch assembly, referred to hereafter as clutch assembly 574, disposed between a motor 518 and a drive member 552, wherein the drive member 552 is then configured in operable driving communication with first and second cable drums 526a, 526b of cable drum mechanism 526, as discussed above for cable-operated drive mechanism 415. Clutch assembly 574 is able to regulate torque transmitted between motor 518 and first and second cable drums 526a, 526b, as desired, such as during unobstructed movement of sliding door 12 or during obstructed movement of sliding door 12, as will be readily understood by a person possessing ordinary skill in the art of clutches. Otherwise, cable-operated drive mechanism 515 is the same as discussed above for cable-operated drive mechanism 415, and thus, no further discussion is believed necessary.

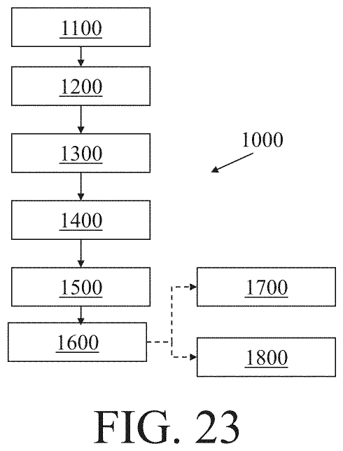

In accordance with a further aspect of the disclosure, as diagrammatically shown in FIG. 23, a method 1000 of minimizing the axial height H of a cable-operated drive mechanism 415, 515 for a powered motor vehicle sliding closure panel 12 is provided. The method includes a step 1100 of providing a housing 424, 524; a step 1200 of providing a motor 418, 518 configured to rotate an output shaft 422 in opposite directions; a step 1300 of supporting a cable drum mechanism 426, 526 in the housing 424, 524 and providing the cable drum mechanism 424, 524 including a first cable drum 426a, 526a supported for rotation in opposite first and second directions about a first drum axis 428 in response to rotation of the output shaft 422 and a second cable drum 426b, 526b supported for rotation in opposite first and second directions about a second drum axis 429 in response to rotation of the output shaft 422. Further, a step 1400 of providing a first cable 430 configured to wind about the first cable drum 426a, 526a in response to the first cable drum 426a, 526a rotating in the first direction and to unwind from the first cable drum 426a, 526a in response to the first cable drum 426a, 526a rotating in the second direction; a step 1500 of providing a second cable 432 configured to unwind from the second cable drum 426b, 526b in response to the second cable drum 426b, 526b rotating in the first direction and to wind about the second cable drum 426b, 526b in response to the second cable drum 426b, 526b rotating in the second direction; and a step 1600 of arranging the first drum axis 428 and the second drum axis 429 in laterally spaced relation from one another.

In accordance with another aspect of the disclosure, the method 1000 can further include a step 1700 of arranging the first drum axis 428 and the second drum axis 429 in parallel relation with one another.

In accordance yet with another aspect of the disclosure, the method 1000 can further include a step 1800 of arranging the first cable drum 426a, 526a and the second cable drum 426b, 526b in coplanar relation with one another, such that a plane P (FIG. 21) extending transversely to the first and second drum axes 428, 429 extends between opposite substantially planar faces 462, 464 of the first cable drum 426a, 526a and the second cable drum 426b, 526b.

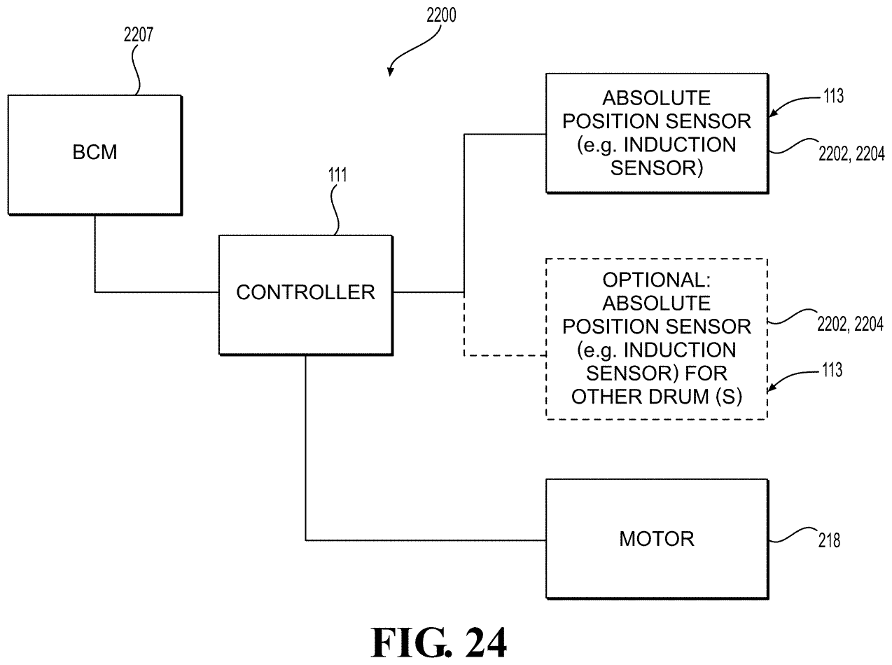

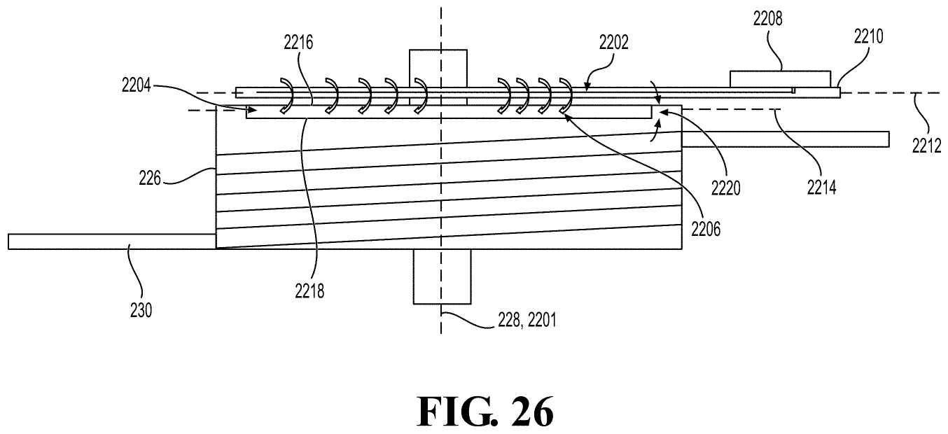

Referring to FIG. 24, an exemplary drive mechanism control system 2200 is shown. The drive mechanism control system 2200 includes the motor 218 for rotating the output shaft 222 (FIGS. 12A-12B) about a primary central axis 2201 (e.g., first drum axis 228 or second drum axis 229). While not shown in FIG. 24, the drive mechanism control system 2200 also includes the powered drive mechanism 215 including the rotatable component 226 coupled to the output shaft 222 and configured to rotate about the primary central axis 2201. The drive mechanism control system 2200 includes a coil 2202. In addition, the drive mechanism control system 2200 includes an object or target 2204 attached to the rotatable component 226 and configured to have a fluctuating inductive coupling with the coil 2202 as the rotatable component 226 is rotated. According to an aspect, the target 2204 has a non-uniform shape. As discussed, the motor 218 is operably coupled to rotatable component 226 (e.g., the at least one cable drum 226) for rotating the rotatable component 226. For example, to move the sliding door 12 during winding and unwinding of the cable 230, 232. The drive mechanism control system 2200 additionally includes the electronic control unit 111 coupled to the coil 2202. The electronic control unit 111 is configured to generate a magnetic field 2206 (FIG. 26) adjacent to the target 2204 using the coil 2202. During rotating of the rotatable component 226 over a full rotation of the rotatable component 226, the target 2204 continuously changes or influences the magnetic field 2206. Thus, the electronic control unit 111 is also configured to sense a variation of the magnetic field 2206 due to the fluctuating inductive coupling with the target 2204 as the rotatable component 226 is rotated (due to the magnetic field 2206 being influenced by the target 2204). In addition, the electronic control unit 111 is configured to determine an absolute position (i.e., angular position) of the rotatable component 226 based on sensing the variation of the magnetic field 2206. The electronic control unit 111 can also be coupled to a body control module (BCM) 2207. Although the drive mechanism control system 2200 may only include a single coil 2202 and a single target 2204, as shown in FIG. 24, more than one coil 2202 and target 2204 may be used (e.g., on associated with the first cable drum 226a and another associated with the second cable drum 226b).

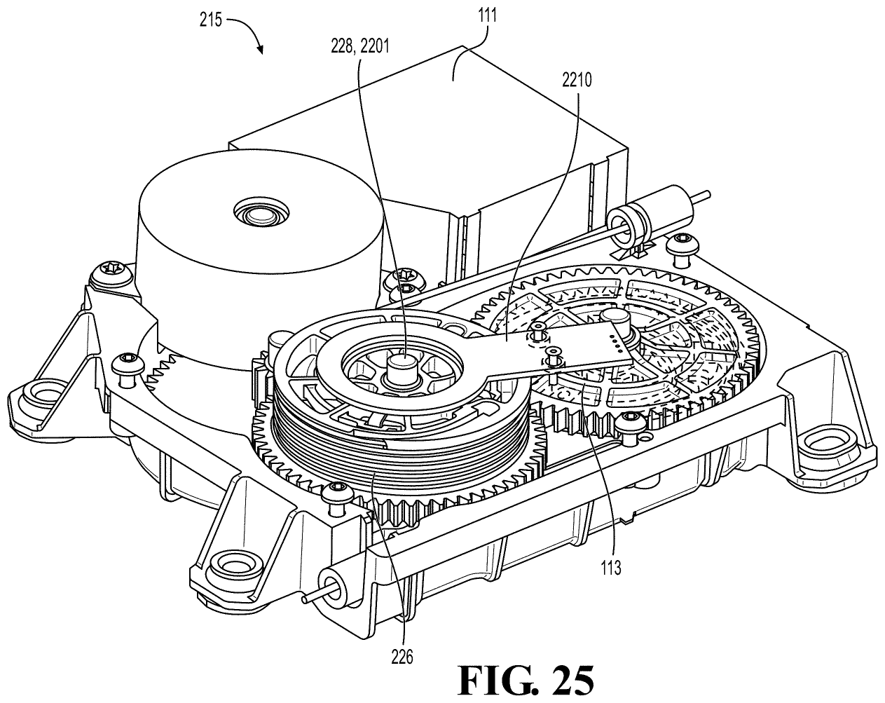

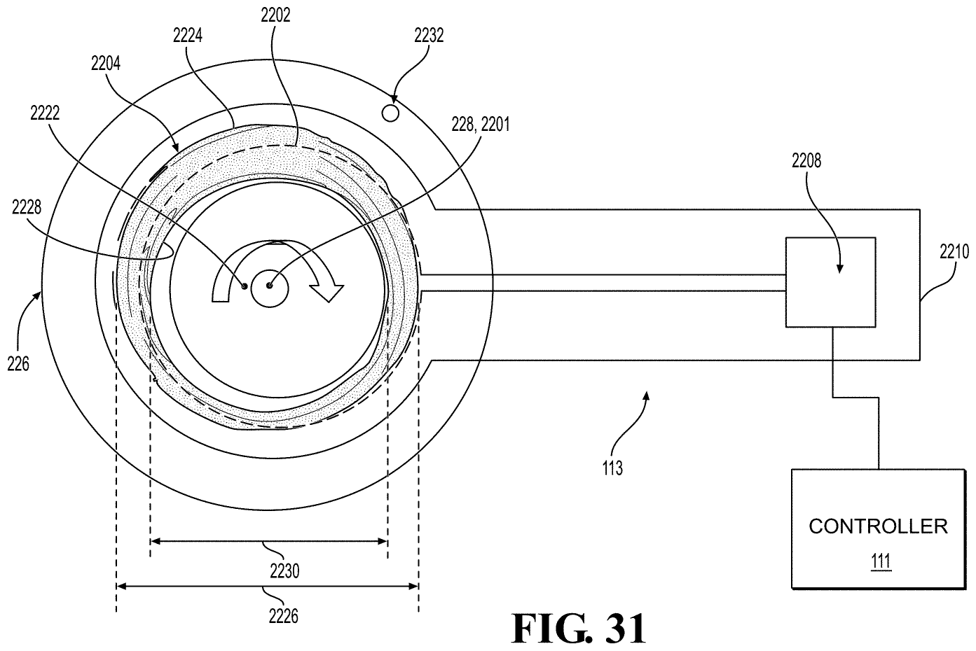

FIGS. 25-26 show an example powered drive mechanism 215 of the drive mechanism control system 2200. According to an aspect, the powered drive mechanism 215 is the cable drum assembly 215 discussed above and the rotatable component 226 is the cable drum 226 of the cable drum assembly 215. So, the coil 2202 and target 2204 comprise the position sensor assembly 113 discussed above (e.g., as part of the drive mechanism control system 2200). The position sensor assembly 113 also includes an induction sensor circuitry unit 2208 (FIG. 26) coupled to the coil 2202. Together, the coil 2202 and the induction sensor circuitry unit 2208 can comprise an induction sensor 2202, 2208. The induction sensor circuitry unit 2208 can couple to or be disposed between the electronic control unit 111 and the coil 2202 (FIG. 31). The induction sensor circuitry unit 2208 is configured to energize the coil 2202 and generate the magnetic field 2206 around the coil 2202 and detect the fluctuating inductive coupling. Although the drive mechanism control system 2200 and position sensor assembly 113 are discussed herein as being associated with the powered drive mechanism 215, for example, it should be appreciated that the drive mechanism control system 2200 and position sensor assembly 113 could instead be used in conjunction with other cable-operated drive mechanisms 15, 115, 315 discussed herein or any other mechanism with a rotatable component.

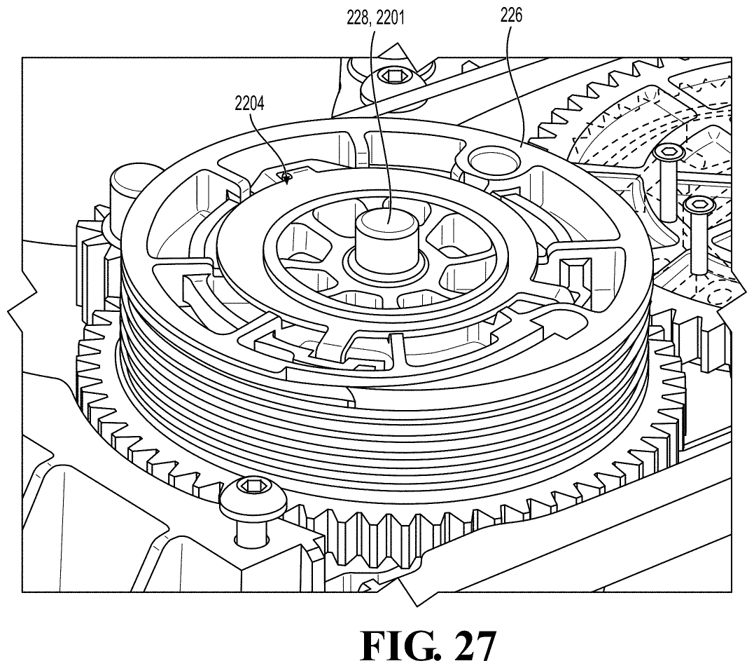

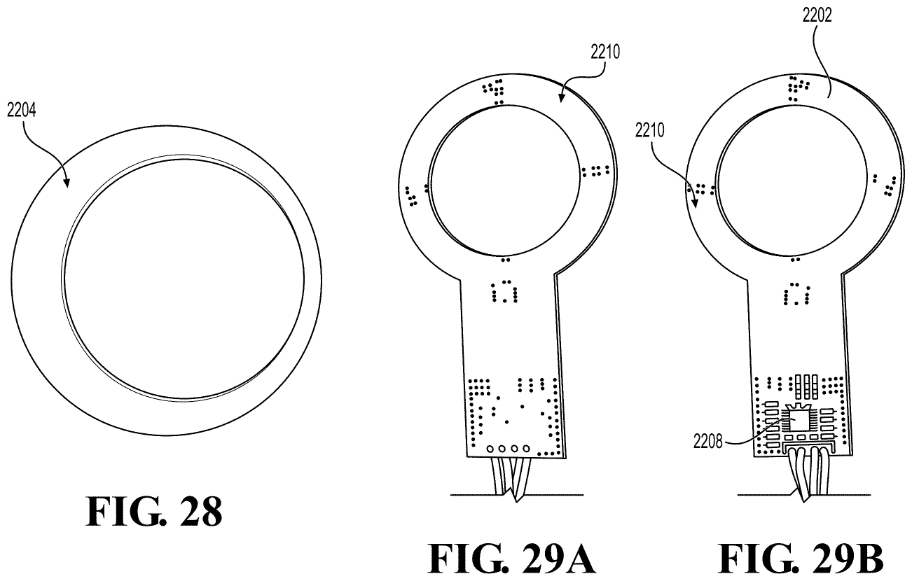

FIGS. 27 and 28 show an example target 2204. Specifically, according to an aspect and best shown in FIG. 28, the target 2204 is a metallic ring 2204 of metal (e.g., steel). FIG. 27 shows the metallic ring 2204 attached to the cable drum 226 of the cable drum assembly 215. According to another aspect and as best shown in FIGS. 29A-29B, the coil 2202 and the induction sensor circuitry unit 2208 are both disposed on a sensor printed circuit board 2210. The sensor printed circuit board 2210 and metallic ring 2204 each define a central aperture to allow a drum shaft to extend through.

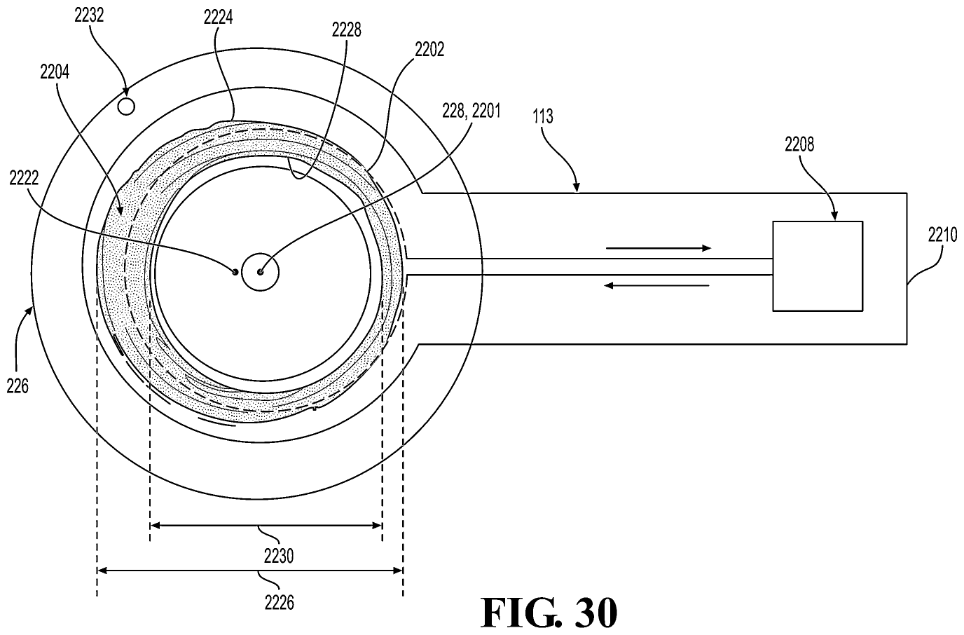

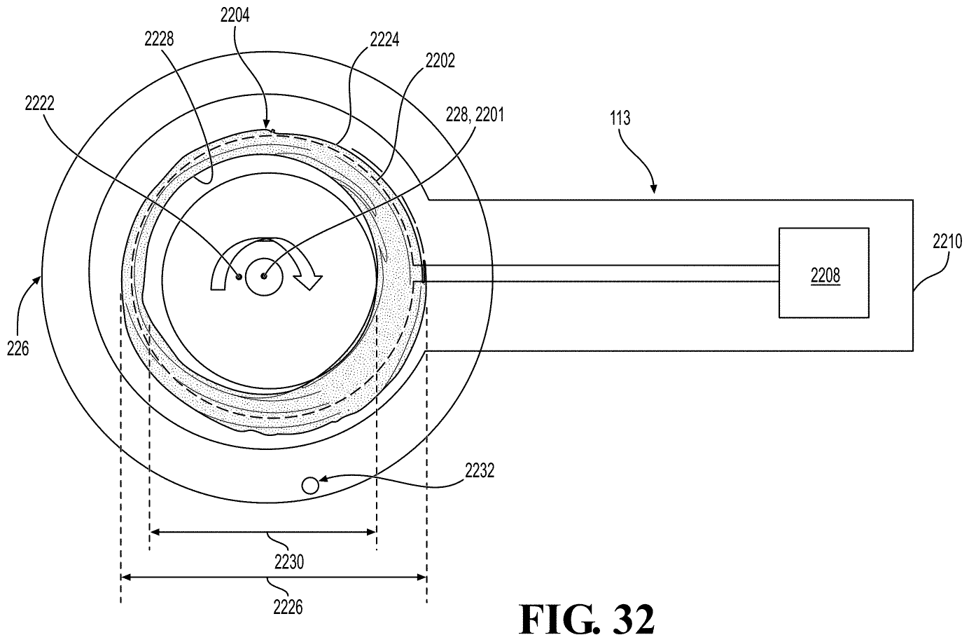

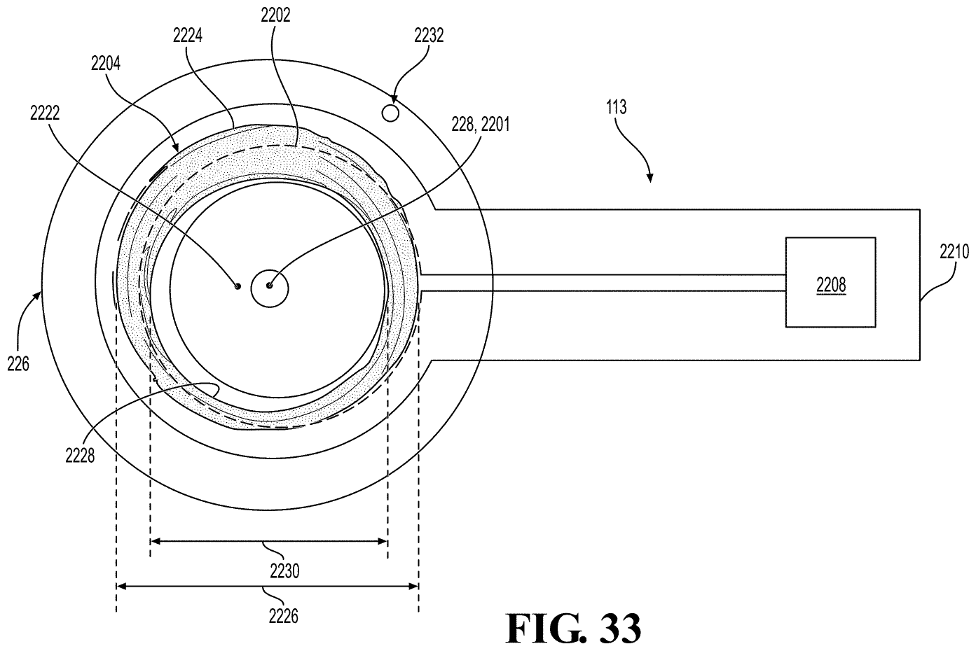

Referring now to FIGS. 30-33 while referring back to FIG. 26, the coil 2202 is annularly shaped about the primary central axis 2201 in a first plane 2212. Thus, the sensor printed circuit board 2210 extends along the first plane 2212 and is parallel to the cable drum 226 and metallic ring 2204. The metallic ring 2204 is annularly shaped and substantially coaxial with the coil 2202 in a second plane 2214 parallel to and in a spaced relationship with the first plane 2212. So, the metallic ring 2204 is configured to have the fluctuating inductive coupling with the coil 2202 varying continuously as the target 2204 is rotated about the primary central axis 2201 relative to the coil 2202. In other words, as the steel target or metallic ring 2204 rotates, the magnetic field 2206 emitted by the coil 2202 of the sensor printed circuit board 2210 changes due to the varied coupling with the metallic ring 2204 and the inductance sensed by the induction sensor circuitry 2208. Since the target or metallic ring 2204 has a different shape relative to the coil 2202 during its angular rotation, the inductance is never the same and therefore the inductance sensed by the induction sensor circuitry 2208 will be different at each position of the cable drum 226. Consequently, the electronic control unit 111 is further configured to energize the coil 2202 adjacent the target 2204 to generate the magnetic field 2206 through which the metallic ring 2204 moves. The electronic control unit 111 is also configured to sense the variation of the magnetic field 2206 as the metallic ring 2204 is rotated with the cable drum 226 of the cable drum assembly 215 to cause a change in the magnetic field 2206.

According to an aspect and still referring to FIGS. 30-33 and back to FIG. 26, the metallic ring 2204 has a ring top 2216 and a ring bottom 2218 opposite the ring top 2216 to define a ring thickness 2220 therebetween. Thus, when attached to the cable drum 226, the ring bottom 2218 abuts the cable drum 226. The metallic ring 2204 may also, for example, be recessed into the cable drum 226, as shown. The metallic ring 2204 extends radially outwardly from a secondary central axis 2222 not coaxial with the primary central axis 2201 to an outer ring perimeter 2224 being circular with a first ring diameter 2226. The metallic ring 2204 also defines a ring opening 2228 extending therethrough that is circular about the primary central axis 2201. The ring opening 2228 has a second ring diameter 2230 less than the first ring diameter 2226. So according to an aspect, the metallic ring 2204 has a continuously varying shape circumferentially. While the ring thickness 2220 is shown as being uniform along the second plane 2214, it should be appreciated that instead of or in addition to the metallic ring 2204 being eccentrically shaped, the metallic ring 2204 may have a non-uniform ring thickness 2220 along the second plane 2214 to cause the variation of the magnetic field 2206 as the metallic ring 2204 is rotated with the cable drum 226. With reference to an imaginary reference point 2232 on the cable drum 226 shown in FIGS. 30-33, the metallic ring 2204 is shown rotating relative to the coil 2202 as the cable drum 226 rotates.

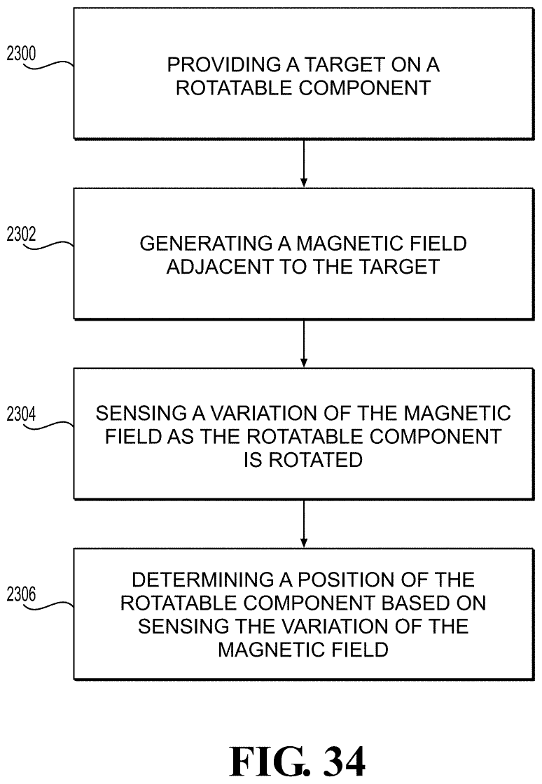

Referring initially to FIG. 34, a method of operating a drive mechanism control system 2200 is also provided. The method includes the step of 2300 providing a target 2204 on a rotatable component 226 being rotatable about a primary central axis 2201. The method also includes the step of 2302 generating a magnetic field 2206 adjacent to the target 2204. The method proceeds with the step of 2304 sensing a variation of the magnetic field 2206 due to a fluctuating inductive coupling with the target 2204 as the rotatable component 226 is rotated. The next step of the method is 2306 determining an absolute position of the rotatable component 226 based on sensing the variation of the magnetic field 2206.

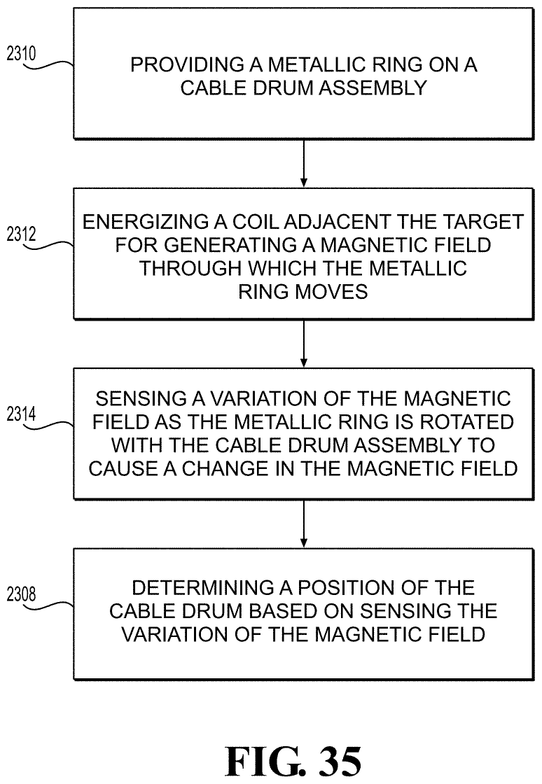

As discussed above, the powered drive mechanism 215 can be the cable drum assembly 215 and the rotatable component 226 can be the cable drum 226 of the cable drum assembly 215. The drive mechanism control system 2200 further includes the induction sensor circuitry unit 2208 coupled to the coil 2202. The induction sensor circuitry unit 2208 is configured to energize the coil 2202 and generate the magnetic field 2206 around the coil 2202 and detect the fluctuating inductive coupling. Thus, now referring to FIG. 35, the step of 2306 determining the absolute position of the rotatable component 226 based on sensing the variation of the magnetic field 2206 includes the step of 2308 determining the absolute position of the cable drum 226 based on sensing the variation of the magnetic field 2206 using the coil 2202 and the induction sensor circuitry unit 2208.

Again, the drive mechanism control system 2200 further includes the coil 2202 that is annularly shaped about the primary central axis 2201 in the first plane 2212. The target 2204 is the metallic ring 2204 of metal that is annularly shaped and substantially coaxial with the coil 2202 in the second plane 2214 parallel to and in a spaced relationship with the first plane 2212. The metallic ring 2204 is configured to have the fluctuating inductive coupling with the coil 2202 varying continuously as the target 2204 is rotated about the primary central axis 2201 relative to the coil 2202. Therefore, still referring to FIG. 35, the step of 2300 providing the target 2204 on the rotatable component 226 includes the step of 2310 providing the metallic ring 2204 on the cable drum 226 of the cable drum assembly 215. The step of 2302 generating the magnetic field 2206 adjacent to the target 2204 includes the step of 2312 energizing the coil 2202 adjacent the target 2204 to generate the magnetic field 2206 through which the metallic ring 2204 moves. Furthermore, the step of 2304 sensing the variation of the magnetic field 2206 due to the fluctuating inductive coupling as the rotatable component 226 is rotated includes the step of 2314 sensing the variation of the magnetic field 2206 as the metallic ring 2204 is rotated with the cable drum 226 of the cable drum assembly 215 to cause a change in the magnetic field 2206.

While the above description constitutes a plurality of embodiments of the present invention, it will be appreciated that the present invention is susceptible to further modification and change without departing from the fair meaning of the accompanying claims.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

What is claimed is:

1. A powered sliding door drive unit for moving a sliding door between an open position and a closed position, comprising:
at least one cable drum for winding and unwinding of a cable coupled to the sliding door;
a motor operably coupled to the at least one cable drum for rotating the at least one cable drum to move the sliding door during winding and unwinding of the cable; and
a proximity sensor adapted to detect the change in the position of the at least one cable drum.

2. The powered sliding door drive unit as set forth in claim 1, wherein the proximity sensor is adapted to detect an absolute position of the at least one cable drum.

3. The powered sliding door drive unit as set forth in claim 1, wherein the proximity sensor is adapted to generate an electromagnetic field for interaction by the at least one cable drum.

4. The powered sliding door drive unit as set forth in claim 3, wherein the at least one cable drum comprises an object, wherein the proximity sensor is further adapted to detect a change in the electromagnetic field in response to interaction by object with the electromagnetic field.

5. The powered sliding door drive unit as set forth in claim 1, wherein the proximity sensor is an induction sensor adapted to generate a magnetic field, the powered sliding door drive unit further comprising an object coupled to the at least one cable drum, wherein the object changes the magnetic field during rotating of the at least one cable drum and the induction sensor is further adapted to detect the change in the magnetic field.

6. The powered sliding door drive unit as set forth in claim 1, wherein the object continuously changes the magnetic field during rotating of the at least one cable drum over a full rotation of the at least one cable drum.

7. The powered sliding door drive unit as set forth in claim 1, wherein the object is formed of metal and has a non-uniform shape.

8. The powered sliding door drive unit as set forth in claim 7, wherein the object is a ring having a continuously varying shape circumferentially.

9. The powered sliding door drive unit as set forth in claim 1, further comprising a controller coupled to the motor and to the induction sensor, wherein the controller is configured to control the motor based on the magnetic field detected by the induction sensor.

10. The powered sliding door drive unit as set forth in claim 9, wherein the controller is configured to determine an absolute position of the at least one cable drum based on the induction sensor detecting the magnetic field continuously changing over a full rotation of the at least one cable drum.

11. The powered sliding door drive unit as set forth in claim 1, wherein:
the at least one drum rotates about a primary central axis;
the induction sensor includes a coil being annularly shaped and disposed about the primary central axis in a first plane and an induction sensor circuitry unit coupled to the coil and configured to energize the coil and generate the magnetic field around the coil;
the object is a metallic ring of metal being annularly shaped and attached to the at least one drum and substantially coaxial with the coil in a second plane parallel to and in a spaced relationship with the first plane, the metallic ring configured to have a fluctuating inductive coupling with the coil varying continuously as the metallic ring is rotated about the primary central axis relative to the coil; and
the induction sensor circuitry unit is configured to detect the fluctuating inductive coupling.

12. The powered sliding door drive unit as set forth in claim 11, wherein the metallic ring has a ring top and a ring bottom opposite the ring top to define a ring thickness therebetween and extends radially outwardly from a secondary central axis not coaxial with the primary central axis to an outer ring perimeter being circular with a first ring diameter, the metallic ring defines a ring opening being circular about the primary central axis and extending through the metallic ring and having a second ring diameter less than the first ring diameter.

13. The powered sliding door drive unit as set forth in claim 11, wherein the powered sliding door drive unit comprises a configuration of at least one of the coil and the induction sensor circuitry unit both disposed on a sensor printed circuit board extending along the first plane; and the metallic ring formed of steel.

14. A drive mechanism control system, comprising:
a motor for rotating an output shaft about a primary central axis;
a powered drive mechanism including a rotatable component coupled to the output shaft and configured to rotate about the primary central axis;
a coil;
a target attached to the rotatable component and configured to have a fluctuating inductive coupling with the coil; and
an electronic control unit coupled to the coil and configured to:
generate a magnetic field adjacent to the target using the coil,
sense a variation of the magnetic field due to the fluctuating inductive coupling with the target as the rotatable component is rotated, and
determine an absolute position of the rotatable component based on sensing the variation of the magnetic field.

15. The drive mechanism control system as set forth in claim 14, wherein the powered drive mechanism is a cable drum assembly and the rotatable component is a cable drum of the cable drum assembly.

16. The drive mechanism control system as set forth in claim 15, wherein the drive mechanism control system further includes an induction sensor circuitry unit coupling the electronic control unit to the coil and configured to energize the coil and generate the magnetic field around the coil and detect the fluctuating inductive coupling and the electronic control unit is configured to determine the absolute position of the cable drum based on sensing the variation of the magnetic field.

17. The drive mechanism control system as set forth in claim 16, wherein the coil is annularly shaped about the primary central axis in a first plane and the target is a metallic ring of metal that is annularly shaped and substantially coaxial with the coil in a second plane parallel to and in a spaced relationship with the first plane and configured to have the fluctuating inductive coupling with the coil varying continuously as the target is rotated about the primary central axis relative to the coil and the electronic control unit is further configured to:
energize the coil adjacent the target to generate the magnetic field through which the metallic ring moves; and
sense the variation of the magnetic field as the metallic ring is rotated with the cable drum of the cable drum assembly to cause a change in the magnetic field.

18. The drive mechanism control system as set forth in claim 14, wherein the metallic ring has a ring top and a ring bottom opposite the ring top to define a ring thickness therebetween and extends radially outwardly from a secondary central axis not coaxial with the primary central axis to an outer ring perimeter being circular with a first ring diameter, the metallic ring defines a ring opening being circular about the primary central axis and extending through the metallic ring and having a second ring diameter less than the first ring diameter.

19. The drive mechanism control system as set forth in claim 18, wherein the coil and the induction sensor circuitry unit are both disposed on a sensor printed circuit board extending along the first plane.

20. A method of operating a drive mechanism control system comprising the steps of:
providing a target on a rotatable component being rotatable about a primary central axis;
generating a magnetic field adjacent to the target;
sensing a variation of the magnetic field due to a fluctuating inductive coupling with the target as the rotatable component is rotated; and
determining an absolute position of the rotatable component based on sensing the variation of the magnetic field.
